(19) United States
(12) Patent Application Publication
(10) Pub. No.: US 2026/0339422 A1
(43) Pub. Date: Oct. 29, 2026

(54) DISPLAY CONTROL DEVICE, DISPLAY CONTROL METHOD, AND DISPLAY CONTROL PROGRAM

(71) Applicant: Sony Group Corporation, Tokyo (JP)

(72) Inventors: Goro TAKAKI, Tokyo (JP); Tomohiro ISHII, Tokyo (JP); Yoriko KONO, Tokyo (JP)

(73) Assignee: Sony Group Corporation, Tokyo (JP)

(21) Appl. No.: 19/113,428

(22) PCT Filed: Sep. 26, 2023
(86) PCT No.: PCT/JP2023/034925

§ 371 Date: Mar. 20, 2025

(30) Foreign Application Priority Data
Oct. 13, 2022 (JP) 2022-165071

(51) Int. Cl. G06F 3/01; G06F 3/04815; G06F 3/16

(52) U.S. Cl. CPC G06F 3/011; G06F 3/04815; G06F 3/16

(57) ABSTRACT

A display control device according to an aspect of the present disclosure includes: an acquisition unit that acquires a behavior of a user in a real space as input information; a determination unit that determines whether or not input corresponding to a specific motion registered in advance is included in the input information; and a display control unit that reflects the behavior of the user corresponding to the input information in an avatar in a virtual space, and in a case where it is determined that the input information includes the input corresponding to the specific motion, further reflects the specific motion in the avatar in the virtual space to display the avatar in the virtual space.

### FIELD

The present disclosure relates to a display control device, a display control method, and a display control program for expressing an avatar in virtual reality.

### BACKGROUND

Various types of technology for presenting, to a user, a three-dimensional virtual space configured in a computer or a computer network, which is referred to as meta-verse or the like, have been put into practical use.

For example, there is proposed technology of providing an avatar having excellent operability to a user or enabling background display conforming to the reality by applying technology related to virtual reality (VR) or augmented reality (AR) to expression in a virtual space (for example, Patent Literature 1).

### CITATION LIST

### Patent Literature

Patent Literature 1: WO 2014/119098 A

### Summary

### Technical Problem

However, there is still room for improvement in the method of expressing an avatar in a virtual space.

For example, in a virtual space, users can communicate closely with each other using avatars. Therefore, it is desirable that the service side that provides the virtual space not only reproduce realistic motions in the avatars conforming to the reality but also provides an avatar that expresses various emotional expressions and various motions likable to the user.

Therefore, the present disclosure proposes a display control device, a display control method, and a display control program that can variously express an avatar in a virtual space.

### Solution to Problem

In order to solve the above problems, a display control device according to an aspect of the present disclosure includes: an acquisition unit that acquires a behavior of a user in a real space as input information; a determination unit that determines whether or not input corresponding to a specific motion registered in advance is included in the input information; and a display control unit that reflects the behavior of the user corresponding to the input information in an avatar in a virtual space, and in a case where it is determined that the input information includes the input corresponding to the specific motion, further reflects the specific motion in the avatar in the virtual space to display the avatar in the virtual space.

### BRIEF DESCRIPTION OF DRAWINGS

FIG. 1 is a diagram illustrating an overview of display control processing according to an embodiment.

FIG. 2 is a diagram illustrating an example of determination processing according to the embodiment.

FIG. 3 is a diagram illustrating a configuration example of a display control device of the embodiment.

FIG. 4 is a table illustrating an example of a gesture storage unit of the embodiment.

FIG. 5 is a flowchart illustrating a flow of display control processing of the embodiment.

FIG. 6 is a diagram (1) for explaining a first variation of the display control processing of the embodiment.

FIG. 7 is a diagram (2) for explaining the first variation of the display control processing of the embodiment.

FIG. 8 is a diagram (1) for explaining a second variation of the display control processing of the embodiment.

FIG. 9 is a diagram (2) for explaining the second variation of the display control processing of the embodiment.

FIG. 10 is a diagram (3) for explaining the second variation of the display control processing of the embodiment.

FIG. 11 is a diagram (1) for explaining a third variation of the display control processing of the embodiment.

FIG. 12 is a diagram (2) for explaining the third variation of the display control processing of the embodiment.

FIG. 13 is a diagram (3) for explaining the third variation of the display control processing of the embodiment.

FIG. 14 is a diagram (4) for explaining the third variation of the display control processing of the embodiment.

FIG. 15 is a diagram (5) for explaining the third variation of the display control processing of the embodiment.

FIG. 16 is a diagram (6) for explaining the third variation of the display control processing of the embodiment.

FIG. 17 is a diagram (1) for explaining a fourth variation of the display control processing of the embodiment.

FIG. 18 is a diagram (2) for explaining the fourth variation of the display control processing of the embodiment.

FIG. 19 is a diagram (3) for explaining the fourth variation of the display control processing of the embodiment.

FIG. 20 is a diagram (1) for explaining a fifth variation of the display control processing of the embodiment.

FIG. 21 is a diagram (2) for explaining the fifth variation of the display control processing of the embodiment.

FIG. 22 is a diagram (3) for explaining the fifth variation of the display control processing of the embodiment.

FIG. 23 is a diagram (4) for explaining the fifth variation of the display control processing of the embodiment.

FIG. 24 is a diagram (5) for explaining the fifth variation of the display control processing of the embodiment.

FIG. 25 is a hardware configuration diagram illustrating an example of a computer that implements the functions of the display control device.

### DESCRIPTION OF EMBODIMENTS

Hereinafter, embodiments will be described in detail on the basis of the drawings. Note that in each of the following embodiments, the same parts are denoted by the same symbols, and redundant description will be The present disclosure will be described in the following order of items.
1. Embodiments
1-1. Outline of Display Control Processing According to Embodiment
1-2. Configuration of Display Control Device According to Embodiment
1-3. Procedure of Processing According to Embodiment
1-4. Variations of Processing According to Embodiment
1-4-1. Liveliness Expression Between Avatars
1-4-2. Expression of Emotion of Avatar
1-4-3. Visualized Expression of Conversation
1-4-4. Proximity Effect Between Avatars
1-4-5. Expression Regarding Avatar Display and Interaction
1-5. Modifications
2. Other Embodiments
3. Effects of Display Control Device According to Present Disclosure
4. Hardware Configuration

### 1. Embodiments

### 1-1. Outline of Display Control Processing According to Embodiment

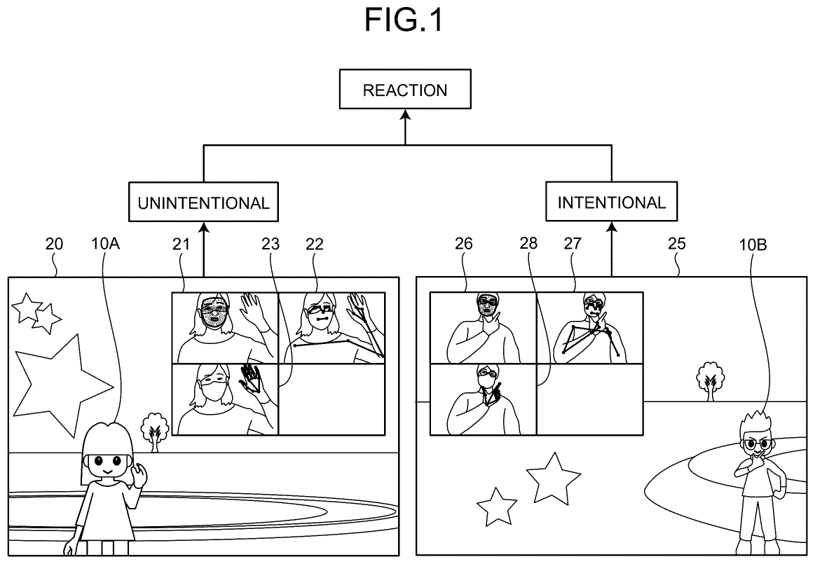

An example of display control processing according to an embodiment will be described with reference to FIG. 1. FIG. 1 is a diagram illustrating an overview of the display control processing according to the embodiment.

The display control processing of the embodiment is executed by a display control device 100 not illustrated in FIG. 1. The display control device 100 is an information processing terminal for implementing VR or AR technology. That is, in the embodiment, the display control device 100 displays a three-dimensional virtual space (hereinafter, simply referred to as a “virtual space”) configured in a computer or a computer network, which is called a meta-verse, on a display unit (such as a display). Furthermore, the display control device 100 displays an avatar that is a character imitating a user in the virtual space. For example, the display control device 100 is implemented by a desired information processing device such as a personal computer (PC), a tablet terminal, or a smartphone. Note that the display control device 100 may be, for example, a head mounted display (HMD), AR glasses, or the like.

For example, the display control device 100 photographs the user in the real space with an image sensor (such as a camera) and reflects the body gesture or facial expression of the user in the avatar in the virtual space. As a result, the user can experience a feeling as if the virtual self exists in the virtual space. Furthermore, since a plurality of avatars (in other words, a plurality of users) can be simultaneously present in the virtual space, the user can perform communication similarly to the real space via the avatar. For example, the user can greet another user or have a conversation (voice chat or text chat) with another user via the avatar to deepen the interaction with the other user.

Since the virtual space can be expressed in various modes, the virtual space can be configured not only as a realistic space conforming to the real space but also as a space involving cartoonish expressions likable to users. In this case, it is desirable that the providing side of the virtual space can not only reproduce realistic motions conforming to the reality in the avatar as the expression of the avatar but also provide various emotional expressions and various motions likable to the user.

Therefore, the display control device 100 according to the present disclosure implements the above processing with the following configuration. For example, the display control device 100 acquires a behavior of the user in the real space as input information and determines whether or not input corresponding to a specific motion registered in advance is included in the input information. Then, the display control device 100 reflects the behavior of the user corresponding to the input information in the avatar in the virtual space, and in a case where it is determined that the input information includes the input corresponding to the specific motion, further reflects the specific motion in the avatar in the virtual space.

Specifically, the display control device 100 registers in advance comical motions including cartoonish expressions such as thumbs-up, taking a favorite pose of each avatar, or a high five as the specific motions (hereinafter, referred to as “gestures”) performed by the avatar. Furthermore, in a case where a motion for igniting the gesture is received as input from the user, the display control device 100 reflects the gesture in the avatar instead of the motion of the user itself. Note that, in a case where the display control device 100 does not receive the gesture from the user, the body gesture itself of the user may be reflected in the avatar. As described above, the display control device 100 reflects both the gesture associated with an intentional motion of the user and an unintentional motion of the user in the avatar. As a result, the display control device 100 can display, in the virtual space, the avatar with expressive and comical motions not only by imitating the motion of the user. Through such expression, the display control device 100 can construct a virtual space that facilitates communication between users or facilitates mutual likeability between users.

Hereinafter, the above display control processing will be described with reference to FIG. 1. As illustrated in the left part of FIG. 1, the display control device 100 displays an avatar 10A existing in a virtual space in a display screen example 20. At this point, the display control device 100 constantly photographs a user corresponding to the avatar 10A (namely, the user whose motion or facial expression is reflected in the avatar 10A) using a camera.

Then, the display control device 100 acquires input information input from the user on the basis of image data obtained from the camera. Note that the input information refers to information acquired from various sensors including the camera and collectively refers to information used for displaying the avatar or the like.

As an example, the display control device 100 acquires facial expression 21 of the user using technology of extracting facial expression on the basis of an image as the input information. The display control device 100 also acquires a bone structure 22 of the user by using technology of estimating the bone structure on the basis of an image. The display control device 100 also acquires body gesture information 23 indicating the movement of the arm or hand of the user using hand tracking technology. Note that the display control device 100 may acquire not only image data but also information of voice or text input from the user as the input information. Then, the display control device 100 integrates these pieces of information and receives input information from the user to be reflected in the avatar 10A.

For example, on the basis of input information of the user, the display control device 100 acquires, as an unintentional motion of the user which is not a specific motion, a gesture in which the avatar 10A nods, shakes its head to indicate the will of rejection, or tilts its head to wonder, or others. Note that the display control device 100 may acquire, as an unintentional motion, various emotional expressions by the user, such as a laughing face or expression or a surprised face or expression by the user. In the present disclosure, these are collectively referred to as “unintentional motion”. The example in the left part of FIG. 1 illustrates an example in which an unintentional motion in which the user raises a hand is reflected in the avatar 10A and displayed in the virtual space.

On the other hand, the display control device 100 can also determine whether or not the user is performing a specific motion for igniting a gesture on the basis of an acquired image data. That is, the display control device 100 determines whether or not input corresponding to a specific motion registered in advance is included in the input information. For example, as illustrated in the right part of FIG. 1, the display control device 100 displays an avatar 10B existing in the virtual space in a screen display example 25. At this point, the display control device 100 constantly photographs a user corresponding to the avatar 10B (namely, the user whose motion or facial expression is reflected in the avatar 10B) using a camera.

Note that, in the example of FIG. 1, the avatar 10A and the avatar 10B are separately drawn for easy understanding of the contrast; however, in practice, an unintentional motion and an intentional motion are expressed in the same avatar. Hereinafter, in a case where it is not necessary to distinguish among the avatar 10A, the avatar 10B, and others, they are simply collectively referred to as “avatars 10”.

In a case where the user performs a specific motion, the display control device 100 accepts a request to shift to an input mode for determining the specific motion. For example, in a case where it is desired that the avatar 10B makes a characteristic gesture on the basis of a specific motion by the user, the user requests the display control device 100 to shift to the input mode for intentionally making the gesture.

Then, the user performs a characteristic motion such as “take a pose registered in advance with the index finger and the thumb in front of the camera”. Similarly to the left part of FIG. 1, the display control device 100 acquires the behavior of the user such as a facial expression 26 of the user, a bone structure 27 of the user, and body gesture information 28 on the basis of a captured image. Then, the display control device 100 integrates the acquired information and determines whether or not the feature of the behavior of the user matches a feature for igniting the gesture registered in advance. Note that various known types of technology may be used for acquisition of the behavior of the user and determination processing of the gesture.

When determining that the behavior input from the user has the movement having the feature sufficient for igniting the gesture, the display control device 100 reflects the gesture in the avatar 10B. For example, as illustrated in the right part of FIG. 1, the avatar 10B takes a pose with the index finger and the thumb. At this point, the display control device 100 may perform a comical expression including a presentation effect in which radial lines are displayed around the avatar 10B together with the pose. With such an expression, the user can distinguish whether the motion of the avatar 10B is a specific gesture registered in advance or the motion of the user itself. In other words, the user intentionally causes the avatar 10B to execute such a specific gesture. Therefore, in the present disclosure, these are collectively referred to as “intentional motions”.

The display control device 100 can reflect both the unintentional motions and the intentional motions in the avatar 10 to express them as a reaction of the avatar 10. As a result, the display control device 100 can display the avatar 10 in the virtual space in various expressions including not only the motion of the user as it is but also with cartoonish expressions.

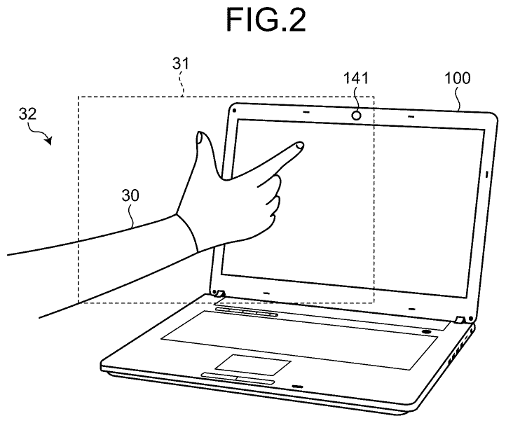

Meanwhile, as described above, the user can switch between input modes of unintentional motions and intentional motions to reflect input information by an unintentional motion or an intentional motion in the avatar 10. Such switching may be performed, for example, on the basis of explicit designation by the user (manual operation such as pressing a button or voice input). Furthermore, the display control device 100 can also set in advance an area in a space in which the user performs the intentional motions and switch the input mode on the basis of such settings. This point will be described by referring to FIG. 2. FIG. 2 is a diagram illustrating an example of the determination processing according to the embodiment.

FIG. 2 illustrates an example in which the user inputs his/her behavior by being photographed by a camera 141 of the display control device 100. At this point, the user performs a hand sign 30 in a preset space 31 (for example, a space within a predetermined distance from the camera 141). The display control device 100 determines whether or not the behavior of the user has been performed in the space 31 using, for example, image analysis, a depth sensor, or the like. Then, in a case where the behavior of the user has been performed in the space 31, the display control device 100 deems that the behavior is to ignite the intentional motion and determines ignition of the gesture. Meanwhile, the display control device 100 reflects the behavior of the user observed in a space 32, which is an area other than the space 31, in the avatar 10 as an unintentional motion.

That is, in a case where the position from the camera 141 is apart by a distance greater than a predetermined distance, the display control device 100 does not determine the input from the user as a motion for igniting a gesture and determines, for only the motions of the user performed in the space 31, whether or not the motion is for igniting a gesture. As a result, the user can desirably reflect unintentional motions and intentional motions in the avatar 10 without explicitly specifying the switching of the input mode.

Note that the switching of the input mode is not limited to the example illustrated in FIG. 2. For example, in a case where the user is performing voice chat (namely, voice input), the display control device 100 may automatically switch to an input mode of extracting unintentional motions (bone detection). Alternatively, in a case where the user is performing text chat (namely, manual character input), the display control device 100 may automatically switch to an input mode of extracting intentional motions (gesture detection).

Furthermore, the display control device 100 may perform motion blending reflecting both types of movement in the middle of performing mode switching. Furthermore, while the user is performing a user interface (UI) operation, the display control device 100 may turn off the input mode itself so that a motion with a different intention is not reflected in the avatar 10. Alternatively, the display control device 100 may activate the gesture input mode only within a predetermined period of time after a desired key operation is performed. Furthermore, the display control device 100 may require input of a predetermined word from the user when performing a gesture to prevent erroneous gesture input. In addition, the display control device 100 may activate the gesture input mode when a mute button for turning off the voice input from the user is pressed and may set the mode to the input mode of unintentional motions in other cases. In addition, when the input mode of unintentional motions is turned off, the display control device 100 may simultaneously turn off the voice input and shift to a privacy mode (not accepting input from the user). As described above, the display control device 100 may use different input modes depending on various modes.

As described above with reference to FIGS. 1 and 2, according to the display control processing of the embodiment, since the unintentional motion and the intentional motion can be desirably reflected in the avatar 10, the avatar 10 can be displayed in various expressions.

### 1-2. Configuration of Display Control Device According to Embodiment

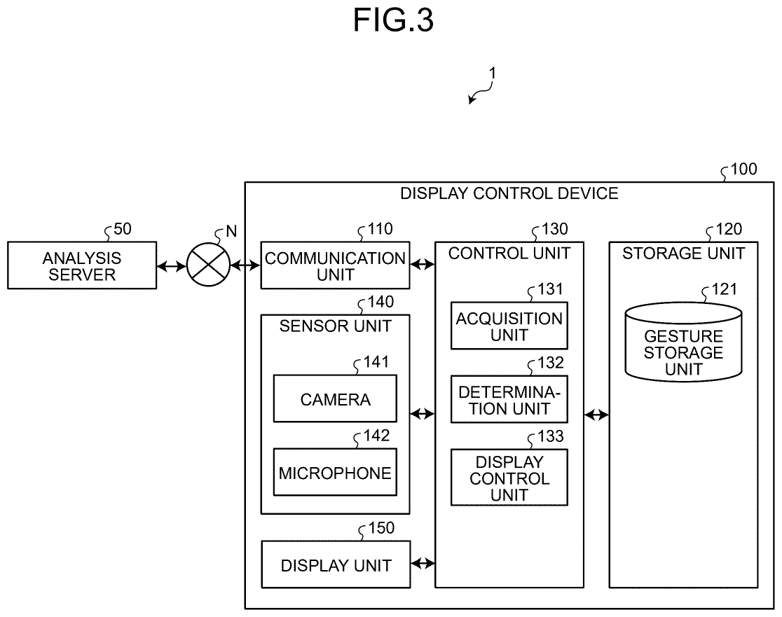

Next, the configuration of the display control device 100 will be described. FIG. 3 is a diagram illustrating a configuration example of the display control device 100 of the embodiment. Note that the display control device 100 is one of components of a display control system 1 according to the embodiment illustrated in FIG. 3. The display control system 1 includes the display control device 100 and an analysis server 50.

The analysis server 50 performs various types of analysis processing to be described later and provides an analysis result to the display control device 100. The analysis server 50 performs, for example, information processing with a relatively high processing load, such as text-based emotion analysis and machine learning processing for image recognition, which are not performed by the display control device 100. For example, the analysis server 50 is a cloud server or the like managed by a business operator or the like that operates services related to the virtual space.

As illustrated in FIG. 3, the display control device 100 includes a communication unit 110, a storage unit 120, a control unit 130, a sensor unit 140, and a display unit 150. Note that the display control device 100 may include an input unit (a keyboard, a touch panel, or the like) that receives various operations from a user who operates the display control device 100.

The communication unit 110 is implemented by, for example, a network interface card (NIC), a network interface controller, or the like. The communication unit 110 is connected to a network N in a wired or wireless manner and transmits and receives information to and from the analysis server 50 and others via the network N. The network N is implemented by, for example, a wireless communication standard or scheme such as Bluetooth (registered trademark), the Internet, Wi-Fi (registered trademark), the ultra-wide band (UWB), or low-power wide area (LPWA).

The storage unit 120 is implemented by, for example, a semiconductor memory element such as a random access memory (RAM) or a flash memory or a storage device such as a hard disk or an optical disk.

The storage unit 120 stores various types of information related to the display control processing of the embodiment. In the embodiment, the storage unit 120 includes a gesture storage unit 121.

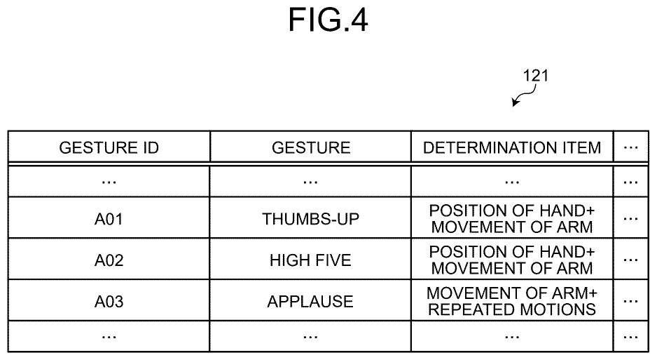

The gesture storage unit 121 will be described with reference to FIG. 4. FIG. 4 is a table illustrating an example of the gesture storage unit 121 of the embodiment. As illustrated in FIG. 4, the gesture storage unit 121 has items such as “gesture ID”, “gesture”, and “determination item”.

“Gesture ID” is identification information for identifying a gesture. “Gesture” indicates the content of a specific gesture. “Determination item” indicates an item for which a feature amount is extracted, the feature amount used for determining whether or not a user's behavior Causes the gesture to be ignited. Note that, although not illustrated in FIG. 4, information of each gesture may include motion data (animation of the bone structure or facial expression, presentation effect, or the like) for moving a 3D model of the avatar 10 depending on the gesture.

For example, the example illustrated in FIG. 4 indicates that a gesture having a gesture ID of “A01” corresponds to “thumbs-up”, and whether or not to cause the gesture to be ignited is determined by “the position of a hand” and “movement of an arm” of the user.

Returning to FIG. 3, the description will be continued. The sensor unit 140 includes a sensor that detects various types of environmental information. For example, the sensor unit 140 includes the camera 141 that is an imaging device including an outward-directed camera that photographs the outside of the display control device 100, an inward-directed camera that photographs the user side, and the like.

For example, the camera 141 recognizes a subject (for example, a user located in the real space) located in front of the display control device 100. In this case, the camera 141 can acquire an image of the user who is the subject and calculate the distance from the display control device 100 (in other words, the camera 141) to the subject on the basis of a parallax between images captured by a stereo camera or an analysis of the captured image data. Alternatively, the sensor unit 140 may detect the distance in the real space using a depth sensor capable of detecting the distance to any subject such as the user.

Furthermore, the sensor unit 140 includes a microphone 142 capable of measuring user's voice and surrounding sound. For example, when performing voice chat, the user can perform voice input by using the microphone 142 included in the display control device 100.

Furthermore, for example, in a case where the display control device 100 is a wearable device such as an HMD, the sensor unit 140 may have a function of detecting various types of information regarding the motion of the user, such as the orientation, inclination, movement, and travelling speed of the body of the user, in addition to the camera 141 and the microphone 142. Specifically, the sensor unit 140 detects, as the information regarding the motion of the user, information regarding the head and posture of the user, the movement (acceleration and angular velocity) of the head and body of the user, the direction of the field of view, the speed of viewpoint movement, or others. For example, the sensor unit 140 functions as various motion sensors such as a three-axis acceleration sensor, a gyro sensor, and a speed sensor, and detects information regarding the user's operation. More specifically, the sensor unit 140 detects components in a yaw direction, a pitch direction, and a roll direction as the movement of the head of the user, thereby detecting a change in at least one of the position of the head or the posture of the user.

Note that the sensor unit 140 is not necessarily included in the display control device 100 and may be, for example, an external sensor connected to the display control device 100 in a wired or wireless manner. For example, the camera 141 is not necessarily included inside the display control device 100 and may be an imaging device installed outside the display control device 100.

The display unit 150 displays various types of information output from the control unit 130. For example, the display unit 150 is a display that outputs a video to the user. Note that the display unit 150 may include a sound output unit (such as a speaker) that outputs sound.

The control unit 130 is implemented by, for example, a central processing unit (CPU), a micro processing unit (MPU), a GPU or the like executing a program (for example, the display control program according to the disclosure) stored inside the display control device 100 using a RAM or the like as a work area. The control unit 130 is also a controller and may be implemented by, for example, an integrated circuit such as an application specific integrated circuit (ASIC) or a field programmable gate array (FPGA).

As illustrated in FIG. 3, the control unit 130 includes an acquisition unit 131, a determination unit 132, and a display control unit 133.

The acquisition unit 131 acquires various types of information. For example, the acquisition unit 131 acquires input information to be reflected in the avatar 10 by sensing the user using the sensor unit 140. Specifically, the acquisition unit 131 acquires the behavior of the user in the real space as the input information.

Furthermore, the acquisition unit 131 may acquire various operations and setting requirements from the user. For example, the acquisition unit 131 receives designation from the user as to whether or not to reflect a specific motion in the avatar 10. That is, the acquisition unit 131 receives, from the user, a specification as to whether or not to set the input mode for inputting unintentional motions or the input mode for inputting intentional motions (gestures).

Furthermore, when acquiring input information, the acquisition unit 131 may acquire surrounding information or the like using the sensor unit 140 or others. Specifically, as illustrated in FIG. 2, the acquisition unit 131 acquires the spatial position from the camera 141 as of the time when a user's behavior is photographed. As a result, the determination unit 132 to be described later can determine at what distance from the camera 141 a hand sign performed by the user is photographed, and thus the mode can be automatically switched to the gesture mode.

Note that the acquisition unit 131 can acquire information regarding not only the user actually photographed by the camera 141 but also a plurality of users connected to the virtual space. That is, the acquisition unit 131 can acquire behaviors of the plurality of users as input information. By using such input information of a plurality of users, the determination unit 132 can determine liveliness or the like of a conversation by the plurality of users as described later.

Furthermore, the acquisition unit 131 may receive various requests transmitted from the user via the UI. For example, the acquisition unit 131 receives various operations for the service related to the virtual space such as a request to change the appearance of the avatar or purchase, selection, or exchange of an object (such as an item in the virtual space) associated with the avatar.

The determination unit 132 performs various determinations for display control of the avatar 10. For example, the determination unit 132 determines whether or not input corresponding to a specific motion registered in advance is included in the input information from the user. The input corresponding to the specific motion registered in advance refers to, namely, a registered behavior for the user to ignite a gesture.

For example, in a case where there is designation of an input mode (designation of a gesture mode) from the user, the determination unit 132 determines whether or not input corresponding to a specific motion is included in the input information. That is, the determination unit 132 determines whether or not the behavior performed by the user in front of the camera 141 is an intentional motion for igniting a gesture.

Furthermore, in a case where the mode is changed depending on the distance, the determination unit 132 does not determine whether or not input corresponding to a specific motion is included in the input information in a case where the position from the camera 141 is apart by a distance greater than a predetermined distance and determines whether or not input corresponding to a specific motion is included in the input information in a case where the position from the camera 141 is within the predetermined distance. That is, the determination unit 132 performs gesture determination on a behavior such as a hand sign performed by the user at a position relatively close to the camera 141 and does not perform gesture determination on a behavior such as a hand sign performed by the user in an area out of the set spatial area to determine that the behavior is an unintentional motion. As a result, the determination unit 132 can freely switch the input mode to express the avatar 10.

The display control unit 133 controls the display unit 150 to display information output from the control unit 130. That is, the display control unit 133 outputs, to the display, a virtual space video rendered as the video content. Note that the output destination device is not limited to the built-in display but may be a separate information device such as a smartphone or a video output device such as a television.

For example, the display control unit 133 reflects the behavior of the user corresponding to the input information in the avatar 10 in the virtual space on the basis of the input information acquired from the user such as an image capturing the user, voice uttered by the user, or text input by the user. Furthermore, in a case where it is determined that the input information includes input corresponding to a specific motion, the display control unit 133 reflects the gesture which is the specific motion in the avatar 10 in the virtual space and displays the avatar 10 in the virtual space.

For example, in a case of a mode for inputting an unintentional motion, the display control unit 133 reflects, in the avatar 10, bone structure data or the like of the user acquired on the basis of an image capturing the user. Meanwhile, in the case of the gesture mode, in a case where the determination unit 132 determines that the user's behavior causes a gesture to be ignited, the display control unit 133 reflects, in the avatar 10, the gesture that has been registered in advance including specific animation or a presentation effect. In other words, the gesture by the avatar 10 is expressed by animation accompanied by a special movement or presentation such as a thumbs-up, a high five, or an applause. Note that the display control unit 133 may control voice output (laughter registered in advance) or the like by the avatar together with the gesture.

### 1-3. Procedure of Processing According to Embodiment

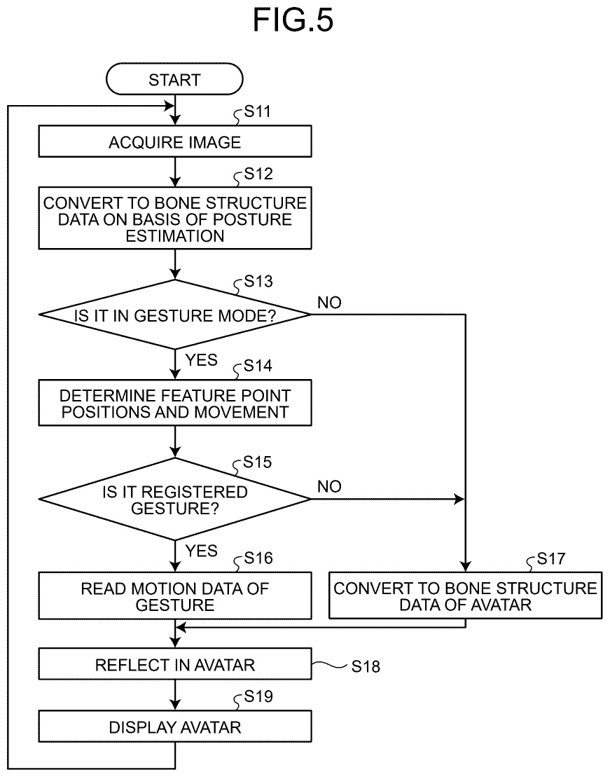

Next, a procedure of processing according to the embodiment will be described by referring to FIG. 5. FIG. 5 is a flowchart illustrating a flow of the display control processing of the embodiment.

As illustrated in FIG. 5, the display control device 100 acquires an image capturing a user using the sensor unit 140 (step S11). Note that, as described above, the display control device 100 may acquire voice of the user, text that has been input, or the like together with the image.

Then, the display control device 100 converts the image of the user into bone structure data on the basis of known posture estimation technique or the like (step S12).

Subsequently, the display control device 100 determines whether or not the current mode is the gesture mode (step S13). If it is the gesture mode (step S13; Yes), the display control device 100 determines feature point positions and the movement in the bone structure data (step S14).

Then, the display control device 100 determines whether or not the feature point positions and the movement correspond to a registered gesture (step S15). If the feature point positions and the movement correspond to a registered gesture (step S15; Yes), the display control device 100 reads motion data of the gesture from the storage unit 120 (step S16). Then, the display control device 100 reflects the read motion data in the avatar 10 (step S18).

If it is not in the gesture mode (step S13; No), the display control device 100 converts the bone structure data obtained from the user into bone structure data of the avatar 10 without performing the gesture determination (step S17). Then, the display control device 100 reflects the bone structure data in the avatar 10 (step S18).

In addition, also in a case where the feature point positions and the movement do not correspond to a gesture in step S15 (step S15; No), the display control device 100 converts the bone structure data obtained from the user into the bone structure data of the avatar 10 (step S17). Then, the display control device 100 reflects the bone structure data in the avatar 10 (step S18).

Thereafter, the display control device 100 displays the avatar 10 in the virtual space on the basis of the information reflected in the avatar 10 (step S19). The display control device 100 repeats such display control processing for each predetermined frame acquired by the sensor unit 140.

### 1-4. Variations of Processing According to Embodiment

### (1-4-1. Liveliness Expression Between Avatars)

The expressions of the avatar 10 with unintentional and intentional motions as described above may be combined with various other expressions. Hereinafter, variations of the display control processing of the embodiment will be described.

First, a first variation will be described. In a first variation, the display control device 100 displays various visual effects depending on the liveliness of a plurality of avatars. Note that the liveliness of the avatars means, in other words, liveliness of users. As a result, the display control device 100 can express that active communication is being performed among a plurality of users in the virtual space in a form that other users can see.

That is, in the first variation, the acquisition unit 131 acquires behaviors of a plurality of users as input information. Then, the determination unit 132 determines the liveliness of the interaction among the plurality of users in the virtual space on the basis of the behaviors of the plurality of users. Furthermore, the display control unit 133 displays a presentation effect depending on the liveliness of the interaction in the vicinity of the plurality of users.

Specifically, the determination unit 132 determines the liveliness of the interaction on the basis of the number of users participating in the interaction, the frequency of conversation among the users, and the degree of overlapping of the voices of the plurality of users.

Furthermore, the display control unit 133 may determine the expression or occurrence frequency of the presentation effect on the basis of the liveliness of the interaction, the orientation of the body of the avatars 10, and the content of the conversations of the plurality of users.

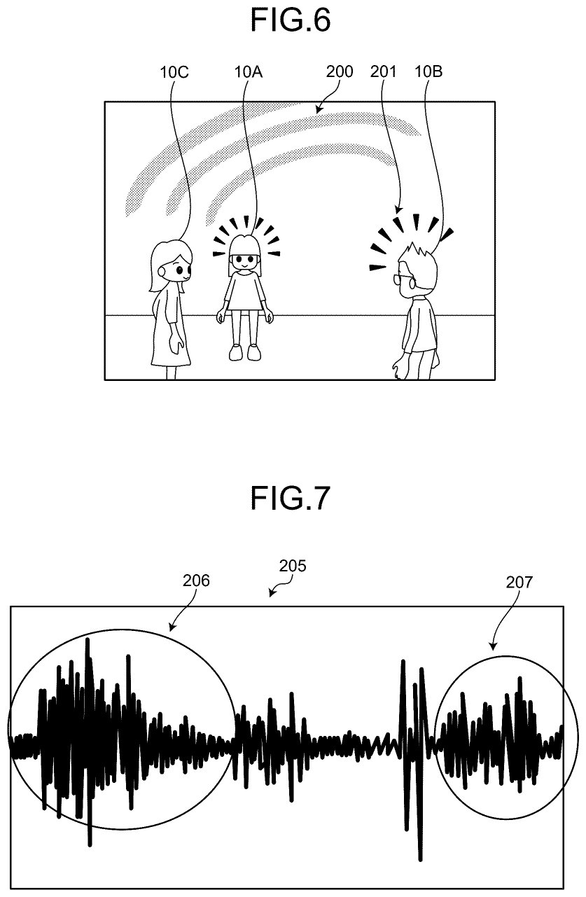

Hereinafter, the first variation will be specifically described with reference to FIG. 6. FIG. 6 is a diagram (1) for explaining the first variation of the display control processing of the embodiment.

The example illustrated in FIG. 6 illustrates that the avatar 10A, the avatar 10B, and an avatar 10C, of a plurality of avatars, actively interact with each other by having greetings or conversations. At this point, the display control device 100 determines the liveliness of the interaction among the plurality of users and displays an arc-shaped presentation effect 200 or radial presentation effects 201 around the avatar on the basis of the liveliness that has been determined. In this manner, the display control device 100 can perform display such that a plurality of avatars actively interacting with each other can be distinguished only by looking at the situation from a distance even if one is not participating in the actual conversation.

Note that the liveliness among the avatars may be derived from various parameters. For example, in a case where the liveliness among the avatars is by voice communication such as voice chat, parameters such as the magnitude, the speed, and the tone of the voice, emotions, the frequency of overlap, the amount of filler, or presence or absence of specific linguistic expressions are used. That is, the liveliness of communication in the virtual space is not necessarily measured only by the magnitude of the voice or the amount of conversation.

For example, under stereophonic sound environment such as a virtual three-dimensional space, simultaneous utterance occurs as in the real space. Therefore, the display control device 100 can use, for example, “overlap (simultaneous utterance of a plurality of persons)” as a parameter of high importance (weighted) of liveliness determination.

Furthermore, the display control device 100 may cause the analysis server 50 or the like to analyze the voice to analyze the emotion of each voice and may calculate the liveliness to be high in a case where a more emotional voice is included. Specifically, the display control device 100 may calculate the liveliness high for an interaction including calls expressing exclamation or strong emotions, such as “I-eh-i (in Japanese)” or “Wow! Yeah! (in English)”. Alternatively, the display control device 100 may calculate the liveliness to be high on the basis of the frequency of occurrence of greetings or words (positive words based on the emotion analysis) containing a strong intention of congratulating or delight, such as “Cheers!”.

Furthermore, the display control device 100 can change a presentation (visual) effect to be displayed depending on the liveliness.

For example, the display control device 100 may change the size or the frequency of the presentation effect indicated by arcs depending on the liveliness. Specifically, in a case where the liveliness is relatively high, the display control device 100 may display a large arc in such a manner as to cover all the plurality of users participating in the conversation. As a result, the display control device 100 can accurately convey the liveliness of the plurality of users to a user who observes the plurality of users from a distance.

In addition, the display control device 100 may display the presentation effect largely even if the conversation is not necessarily lively. For example, in a case where a plurality of users pays attention to a certain event in the virtual space, it is determined that the interaction for the plurality of users is lively although the amount of conversation is small. In this case, for example, the display control device 100 may determine the liveliness based on exchange of the avatars' glances or an interaction by other than conversation (closeness of the distance among the users, or the like). Then, the display control device 100 displays an arc-like or radial presentation effect larger than usual or brighter than usual depending on the liveliness. As a result, the display control device 100 can indicate to other users that the plurality of users is actively interacting with each other without depending on a conversation.

Next, an example of processing in which the display control device 100 determines the liveliness will be described with reference to FIG. 7. FIG. 7 is a diagram (2) for explaining the first variation of the display control processing of the embodiment.

FIG. 7 is a diagram illustrating a synthesized waveform 205 acquired from conversations of a plurality of users. In FIG. 7, a range 206 indicates a waveform in which the volume of the voices of the plurality of users is measured to be high, which indicates that a conversation with a relatively large voice is performed. Furthermore, a range 207 indicates a waveform in which a large number of voices of a plurality of users are combined, which indicates that active conversations are exchanged.

The display control device 100 determines the liveliness of the plurality of users on the basis of such waveform analysis. For example, the display control device 100 determines the liveliness on the basis of a feature of a volume change in a predetermined period of time. Alternatively, the display control device 100 may estimate the number of participants in the conversation on the basis of the waveform analysis and determine the liveliness to be higher as the estimated number of participants is larger.

Furthermore, the display control device 100 may change the expression of the presentation effect on the basis of the waveform. For example, the display control device 100 may change the color or the density (occurrence frequency) of the arc shapes or the radial shape to be displayed, the speed at which the arcs or the radial shape spreads, and the like depending on the amplitude of the waveform.

Furthermore, the display control device 100 may not necessarily perform arc-shaped expression as the presentation effect but may rather perform display on a balloon having a continuous acute angle depending on the voice, the conversation content, or emotions. As a result, the display control device 100 can express, for example, that a plurality of users are quarreling with each other. In this case, the display control device 100 may display the presentation effect such as a balloon in three-dimensional display (application of a rim shader) that is formed regardless of the viewing angle.

Furthermore, the display control device 100 may change the speed at which the presentation effect occurs depending on the distance from the observer to the plurality of users. Specifically, the display control device 100 may display the presentation effect more slowly as the distance is longer and display the presentation effect faster as the distance is shorter. As a result, the observing user can grasp at a glance how far the actively interacting users are.

### (1-4-2. Expression of Emotion of Avatar)

Next, a second variation will be described. In the second variation, the display control device 100 acquires input in which emotions are strongly indicated, such as a laughter of a user and reflects a gesture of laughter in the avatar 10 in a case where it is determined that the user is laughing.

That is, in the second variation, the determination unit 132 determines whether or not input corresponding to a specific motion associated with a specific emotion such as laughter is included in the input information from the user. In a case where it is determined that the input information includes a specific motion associated with a specific emotion, the display control unit 133 reflects the specific motion associated with the specific emotion in the avatar 10.

At this point, the determination unit 132 may determine whether or not the input information includes input corresponding to a specific motion associated with a specific emotion by comparing voiceprint information associated with a specific emotion with the input information, the voiceprint information registered in advance by the user.

Furthermore, the display control unit 133 may display the avatar 10 reflecting the specific motion associated with the specific emotion and display a presentation effect associated with the specific emotion in the vicinity of the avatar 10.

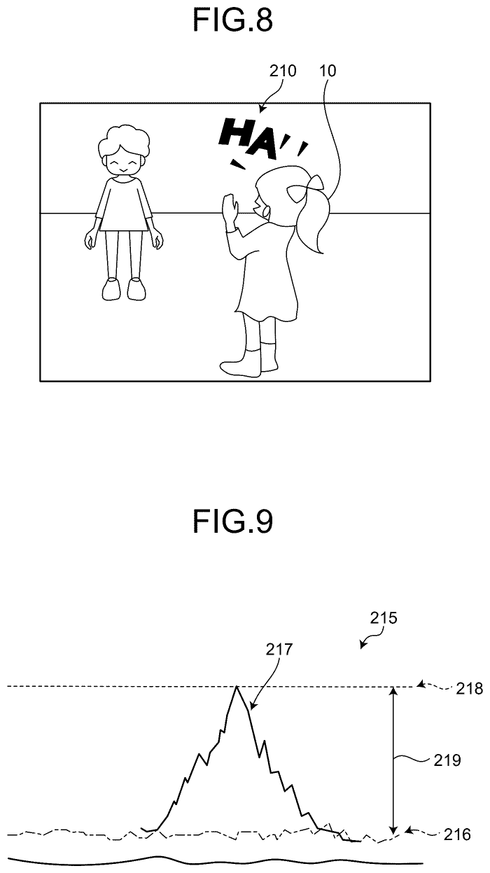

The second variation will be specifically described with reference to FIG. 8 and subsequent drawings. FIG. 8 is a diagram (1) for explaining the second variation of the display control processing of the embodiment.

The example illustrated in FIG. 8 indicates that the avatar 10 is making a gesture in association with “laughter” which is an example of the specific emotion. At this point, the display control device 100 may display a presentation effect 210 of a comical expression associated with laughter around the avatar 10. That is, the display control device 100 can display the avatar 10 rich in emotional expressions by causing the avatar 10 to execute the gesture of laughter in response to the laughing user.

The display control device 100 can determine that the user laughed by some methods. This point will be described by referring to FIG. 9. FIG. 9 is a diagram (2) for explaining the second variation of the display control processing of the embodiment.

FIG. 9 is a diagram illustrating an example of a voice waveform 215 acquired from a user. In the voice waveform 215, a measurement value, when environmental sound (background noise) when the user performs a voice chat or the like is measured, is set as a measurement result 216. Furthermore, in the voice waveform 215, a voice waveform when the user performs the voice chat or the like is denoted as a measurement result 217. At this point, the peak of the measurement result 217 is indicated by a line of a result 218. The difference between the result 218 and the measurement result 216 is indicated by a difference 219.

That is, the display control device 100 measures the environmental sound (background noise) when the user performs the voice chat or the like using the microphone 142. Then, the display control device 100 measures the user's voice, estimates the peak of the volume as a laughter, and measures the difference 219 from the environmental sound. In this manner, the display control device 100 registers the difference value between the peak value of the voice and the environmental sound for each user.

Then, the display control device 100 determines that the user has laughed when the user utters voice and voice exceeding the difference 219 (or an equivalent voice) is observed next time. According to such a method, the display control device 100 can determine whether or not the user has laughed on the basis of the volume.

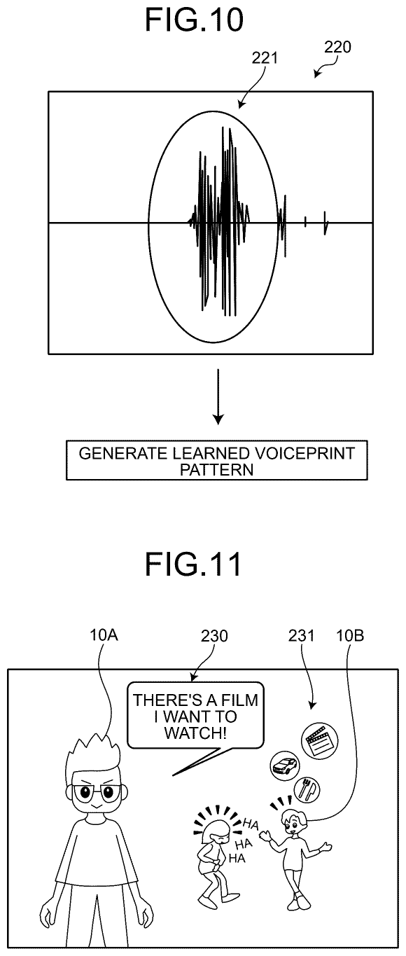

Note that, as another method, the display control device 100 can learn voiceprint information when the user smiles and perform determination based on such a learning result. This point will be described by referring to FIG. 10. FIG. 10 is a diagram (3) for explaining the second variation of the display control processing of the embodiment.

FIG. 10 is a diagram illustrating an example of a voice waveform 220 acquired from a user. A range 221 of the voice waveform 220 indicates a waveform when a laugher of the user is measured. The display control device 100 (or the analysis server 50) accumulates waveforms when a laughter is measured for each user and learns a feature of the accumulated waveforms by a known speech learning method (such as deep learning for extracting a characteristic pattern). As a result, the display control device 100 can generate a learned voiceprint pattern indicating the state of “laughter” for each user.

Then, when the user next utters voice and a voice waveform is acquired, the display control device 100 can determine whether or not the voice includes a laughter by comparing the voice waveform with the learned voiceprint pattern. As a result, the display control device 100 can determine whether or not the user has laughed with high accuracy.

Note that human laughter varies, and emotions contained in the laughter include not only joy but also various emotions. Therefore, in a machine learning model that determines a laughter by learning, the display control device 100 may generate the model in such a manner as to categorize emotions or the like instead of binary determination of whether or not the user is laughing or not.

In addition, several methods are conceivable as a method of acquiring a laughter as learning data. For example, the display control device 100 acquires a waveform indicating a laughter on the basis of explicit designation by the user. Specifically, the display control device 100 acquires the voice of the user when the user presses a button for causing the display control device 100 to acquire (record) a laughter. At this point, the user utters laughter in a desired manner. As a result, the display control device 100 can acquire a voiceprint pattern (namely, teacher data to which a label of “laughing” is attached) indicating the user's laughter. Alternatively, the display control device 100 may acquire the voiceprint pattern of the user in such a manner as to accumulate only the user's laughter using a general-purpose machine learning model for voice recognition that determines the user's laughter. In general, since the features of the laughter vary among individuals, it is desirable that the display control device 100 acquire and learn the voiceprint pattern for each individual user.

Note that the display control device 100 may acquire voice based on various user's emotions without being limited to the laughter. By reflecting an expression based on the acquired voice in the avatar 10, the display control device 100 can express the user's own emotional expression also in the avatar 10.

As an example, the display control device 100 may acquire a feature of fillers for each user and reflect the feature of the user uttering the fillers in the avatar 10. It can be said that a filler such as “well . . . ” or a habit of saying “sound nice” uttered by the user indicates features of the user. Therefore, the display control device 100 can reproduce the features of the user in the virtual space by learning fillers and the habit of talking for each user and reflecting the filler or the habit of talking in the avatar 10 when the filler or the habit of talking is observed. In this case, the display control device 100 can further reflect the feature of the user in the avatar 10 by adding emphasized and cartoonish expressions such as expressing the voice uttered as a filler or the habit of talking in a balloon in a 3D manner.

### (1-4-3. Visualized Expression of Conversation)

Next, a third variation will be described. In the third variation, a method will be described in which, when the display control device 100 displays a conversation between avatars in a virtual space, not only text indicating a conversation content is displayed in a general balloon but also the conversation content is expressed in various expressions.

For example, in the third variation, the display control unit 133 may display words uttered by the avatar 10 on the basis of the input information and further display a history of words in such a manner as to transition upward starting from the avatar.

Furthermore, the display control unit 133 may display a word uttered by the avatar 10 as an icon representing the semantic content with a picture on the basis of the semantic content included in the input information.

Furthermore, the determination unit 132 may determine a distance between the position in the virtual space from which the display of words is observed (namely, the position where the avatar as the observer is located) and the position of the avatar 10 that utters the words. In this case, the display control unit 133 displays the history of words or an icon as the presentation effect not including words or the semantic content of the icon on the basis of the determined distance. Note that, as an example of the presentation effect that does not include any semantic content, as will be described later, there is a case where the text or the like indicating the conversation content is not displayed, but simply a history of active conversation is expressed in such a manner as a signal fire or a balloon.

Furthermore, the determination unit 132 may determine the positional relationship between the position in the virtual space from which the display of words is observed and the position of the avatar 10 that utters the words. In this case, the display control unit 133 may determine the display angle and the three-dimensional display of the words observed in the virtual space on the basis of the determined positional relationship.

As described above, in the third variation, the display control device 100 displays an icon or displays a conversation including a visual effect instead of a general conversation displayed as text or the like. As a result, the display control device 100 can express that a conversation is actively carried out among avatars at a glance.

The third variation will be specifically described with reference to FIG. 11 and subsequent drawings. FIG. 11 is a diagram (1) for explaining the third variation of the display control processing of the embodiment.

The example illustrated in FIG. 11 indicates that the avatar 10A is having a conversation with an avatar, which is an observer, by saying “There's a film I want to watch!” Since the avatar 10A is talking in the vicinity of the observer, such a conversation is displayed as text in a balloon 230.

Meanwhile, the content of a conversation that the avatar 10B is having at a far side of the avatar 10A is indicated by icons 231. Specifically, the display control device 100 performs content and emotion analysis on the conversation of the avatar 10B by the analysis server 50 and displays the analysis result as the icons 231. In the example of FIG. 11, the icons 231 indicate that the avatar 10B has had a conversation with content such as going to a movie, then getting on a car, and eating out.

As described above, for the conversation of the avatar 10B separated away from the observer by more than a predetermined distance, the display control device 100 does not display the text as it is but displays icons (image or the like) indicating the conversation content. As a result, the observer can grasp a rough conversation content and a situation such as how actively the conversation is carried out without reading character information in detail for the far conversation.

Furthermore, the display control device 100 can display the conversation made between avatars in such an animation as that a past history flows upward, like the icons 231. As a result, the display control device 100 can transmit the flow of conversation to other users in a visually easy-to-understand manner and can also allow distant users to grasp how actively the conversation is carried out.

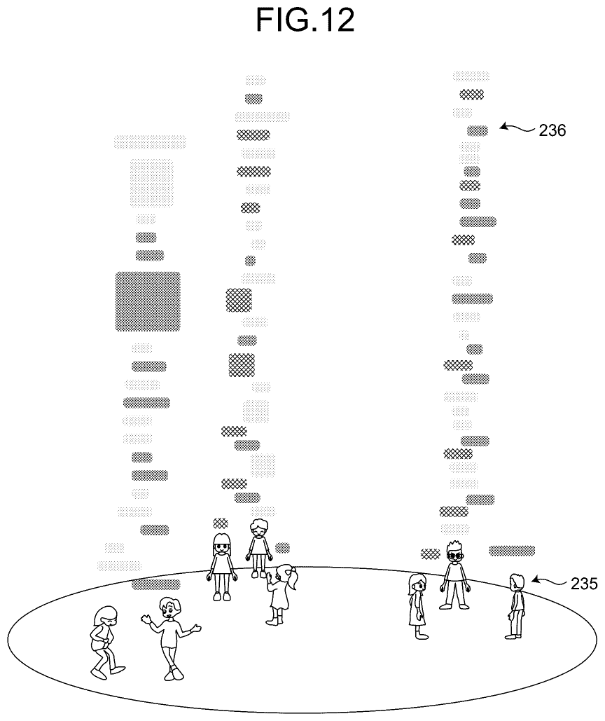

This point will be described by referring to FIG. 12. FIG. 12 is a diagram (2) for explaining the third variation of the display control processing of the embodiment.

FIG. 12 illustrates a situation in which a plurality of avatars 235 is talking as viewed at a very long distance from the observer. At this point, in conversation by the plurality of avatars 235, display including semantic content such as text or icons is omitted, and only histories 236 of conversation in balloons or circular shapes (such display may be referred to as “text balloons”) are displayed.

As described above, the histories 236 of conversation are animated upward in the order of past history. Therefore, in the example of FIG. 12, the conversations of the plurality of avatars 235 are expressed like signal fires in the virtual space. As a result, even a distant observer can know where in the virtual space a conversation is actively carried out.

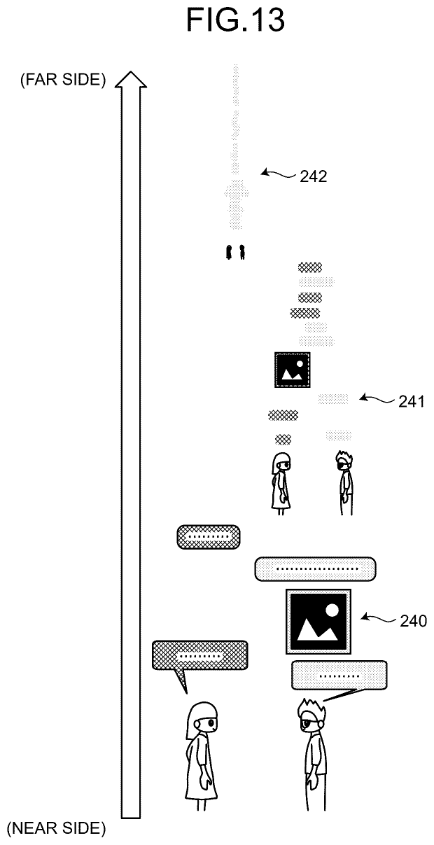

Furthermore, the display control device 100 can variously change the expression method depending on the distance between the observer and the avatar 10. This point will be described by referring to FIG. 13. FIG. 13 is a diagram (3) for explaining the third variation of the display control processing of the embodiment.

FIG. 13 is a diagram illustrating different expressions for a conversation 240 in the vicinity of the observer, a conversation 241 held at a moderate distance from the observer, and a conversation 242 held extremely far from the observer.

For example, in the conversation 240, the conversation content of avatars is displayed as text, and the details of the conversation are displayed. Note that, in the conversation 240, not only the text but also image information shared between the users, such as an image transmitted by a user during the text chat, may be displayed. As a result, the observer can roughly grasp about what type of topic the communication is being carried out without reading the text.

For example, in the conversation 241, text display is omitted for the conversation content of the avatars, and an icon or the like is inserted midway, whereby display is made such that rough conversation content can be grasped by the observer. For example, in the conversation 241, in a case where two avatars are talking, the observer can grasp the conversation content at a granularity of the degree of which avatar is speaking. Incidentally, older histories of the conversation 241 may be displayed in such a manner that strings of text merge into one as they go upward.

For example, in the conversation 242, display of semantic content such as text or icons is omitted for the conversation content of the avatars, and only the history of the conversation is displayed like a signal fire. At this point, the display control device 100 may perform display such that a past history (namely, the upper conversation history) becomes more transparent as in a signal fire in the real space. Furthermore, the display control device 100 may display the display indicating each line smaller than those of the conversation 240 and the conversation 241. That is, the display control device 100 can change the display field such as balloons for displaying lines depending on the distance.

As described above, by changing the expression of the conversation depending on the distance, the display control device 100 can provide the user with a UI that does not complicate the display even when active communication is performed in the virtual space.

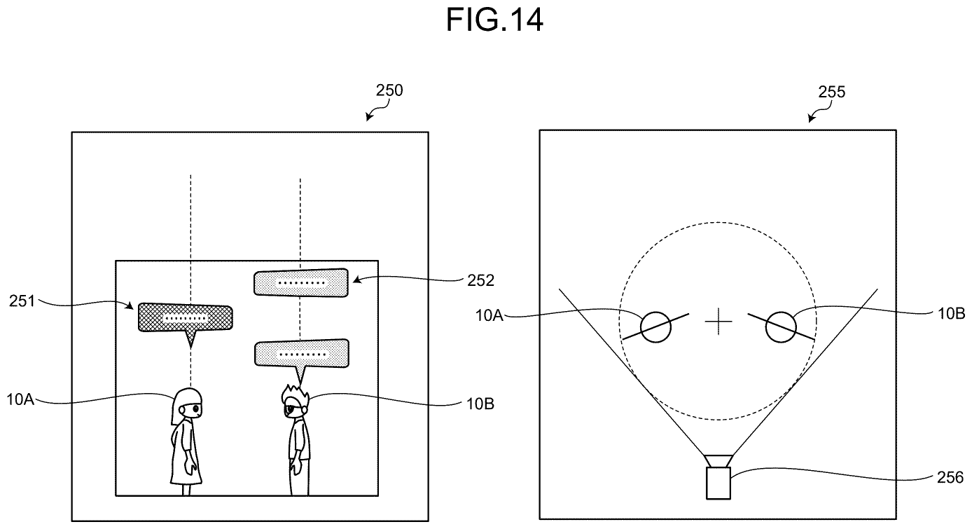

Furthermore, the display control device 100 can variously change the expression method depending on the positional relationship between the observer and the avatar 10. This point will be described by referring to FIG. 14. FIG. 14 is a diagram (4) for explaining the third variation of the display control processing of the embodiment.

A left diagram in FIG. 14 illustrates a situation in which a conversation 250 is being held in the vicinity of the observer. Specifically, in the conversation 250, the avatar 10A and the avatar 10B are having a conversation. Furthermore, the conversation 250 includes a conversation history 251 of the avatar 10A and a conversation history 252 of the avatar 10B.

The right diagram in FIG. 14 illustrates an overhead view display 255 of the conversation 250 as viewed from above. As illustrated in the overhead view display 255, it is based on the premise that the avatar 10A and the avatar 10B do not face an observer 256 and are standing at slightly oblique angles as viewed from the observer 256.

At this point, as illustrated in the left diagram in FIG. 14, the display control device 100 displays the conversation history 251 at an angle on the basis of the positional relationship between the observer 256 and the avatar 10A (in this example, an angle formed by the line of sight of the observer 256 and the orientation of the avatar 10A). Similarly, the display control device 100 displays the conversation history 252 at an angle on the basis of the positional relationship between the observer 256 and the avatar 10B.

With such an expression, the observer 256 can recognize the positional relationship with the avatar 10A or the avatar 10B only by looking at the conversation history.

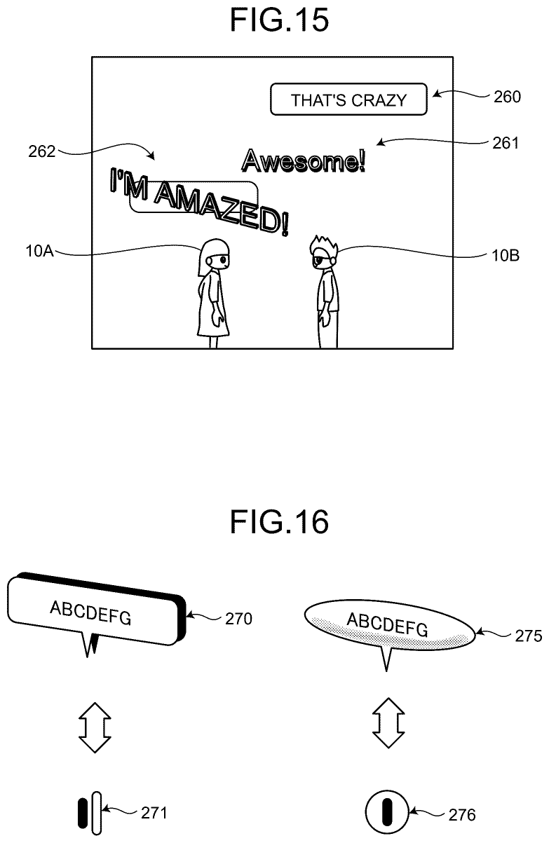

Furthermore, the display control device 100 may perform display in which a presentation effect is included in the conversation content itself such as text in addition to the angle. This point will be described by referring to FIG. 15. FIG. 15 is a diagram (5) for explaining the third variation of the display control processing of the embodiment.

FIG. 15 illustrates a situation in which the avatar 10A and the avatar 10B are having a conversation and in which text 260, a presentation effect 261, and text 262 indicating the conversation content are displayed.

For example, the text 260 may include highlighting, such as being displayed in bold as compared with other text. For example, the display control device 100 automatically performs highlight display when a user utters a word that strongly indicates emotion and is registered in advance such as “crazy”.

Incidentally, the presentation effect 261 is a character icon including three-dimensional display. For example, the presentation effect 261 is automatically displayed when a user utters a word that strongly indicates emotion and is registered in advance such as “crazy”.

In addition, the text 262 includes three-dimensional display. For example, the text 262 is displayed on the basis of a predetermined determination criterion, such as when the user utters a word that is registered in advance and strongly indicates emotion, such as “amazed”, or when the volume of voice of the user is larger than a normal volume.

Note that these special text display and presentation effects may be displayed on the basis of an emotion analysis or the like in the user's conversation. For example, the display control device 100 cooperates with the analysis server 50 to perform positive/negative determination on the content input in a text chat using a sentiment analysis. Then, the display control device 100 automatically generates an appropriate visual effect for a balloon in which text is displayed. Specifically, in a case where the conversation is positive, the display control device 100 may display a balloon or text with a bright color, animation in which characters flick, or the like. Alternatively, in a case where the conversation is negative, the display control device 100 may display a balloon in a cold color or may display a balloon or text with such animation or the like as if the text is weeping.

Furthermore, these balloon and text may be expressed by history display (referred to as word cloud or the like) in which the size of the text varies depending on the frequency of the word appearing in the conversation.

In addition, these types of text display and the like may be accompanied by three-dimensional physical characteristics. This point will be described by referring to FIG. 16. FIG. 16 is a diagram (6) for explaining the third variation of the display control processing of the embodiment.

FIG. 16 is a diagram illustrating an example of text 270 and text 275 with three-dimensional display. The text 270 has such a shape as if characters float from a balloon. Therefore, in display 271 in which the text 270 is viewed from the side, the character portion is expressed as floating from the balloon.

Furthermore, the text 275 has such a shape as if characters are captured in a balloon. Therefore, in a display 276 when the text 275 is viewed from the side, the character portion is expressed in such a manner as to be included in a balloon like a cloud. Therefore, it appears to the observer that the characters are expressed as a two-dimensional plate and that the balloons are expressed in a shape like a three-dimensional cloud or a rubber balloon.

Note that the three-dimensional display illustrated in FIG. 16 and others can also be displayed from the back side. In this case, an image or text in the three-dimensional display is horizontally reversed and displayed.

As described above, the display control device 100 can perform various expressions also for text and others in a conversation, thereby visually entertaining the user.

### (1-4-4. Proximity Effect Between Avatars)

Next, a fourth variation will be described. In the fourth variation, an example is illustrated in which the display control device 100 performs such expression that encourages interaction when avatars are close to each other.

For example, in the fourth variation, the determination unit 132 may determine whether or not a first avatar is included in an area recognized by a second avatar. Then, in a case where it is determined that the first avatar is included in the area recognized by the second avatar, the display control unit 133 may adjust a travelling path of the first avatar such that the first avatar approaches the second avatar.

Furthermore, the determination unit 132 may determine whether or not the first avatar has approached the second avatar in the virtual space. In a case where it is determined that the first avatar has approached the second avatar, the display control unit 133 reflects, in at least one of the first avatar or the second avatar, a specific motion corresponding to the proximity.

That is, in the fourth variation, the display control device 100 causes special display or action to work such that the avatars can recognize the presence of each other and have communication in proximity to each other, thereby promoting interaction among the users.

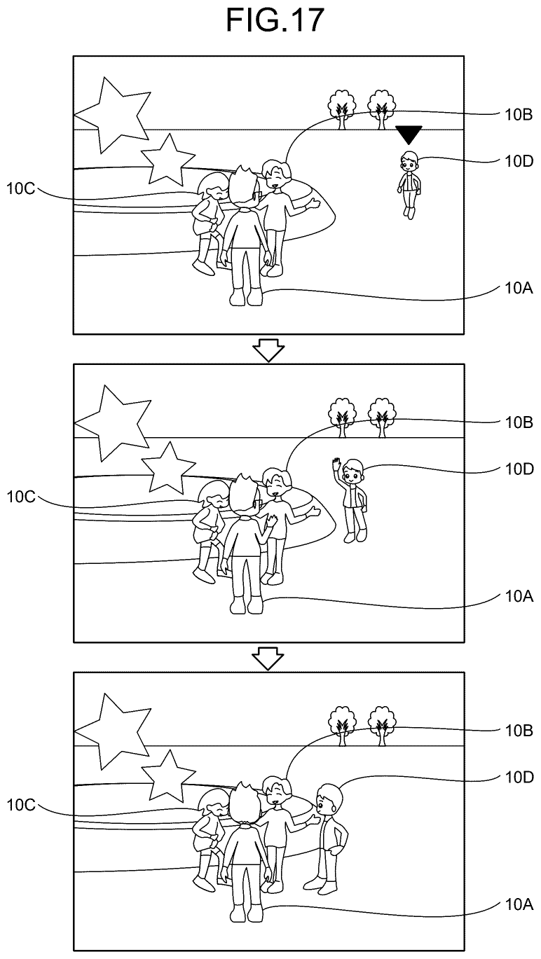

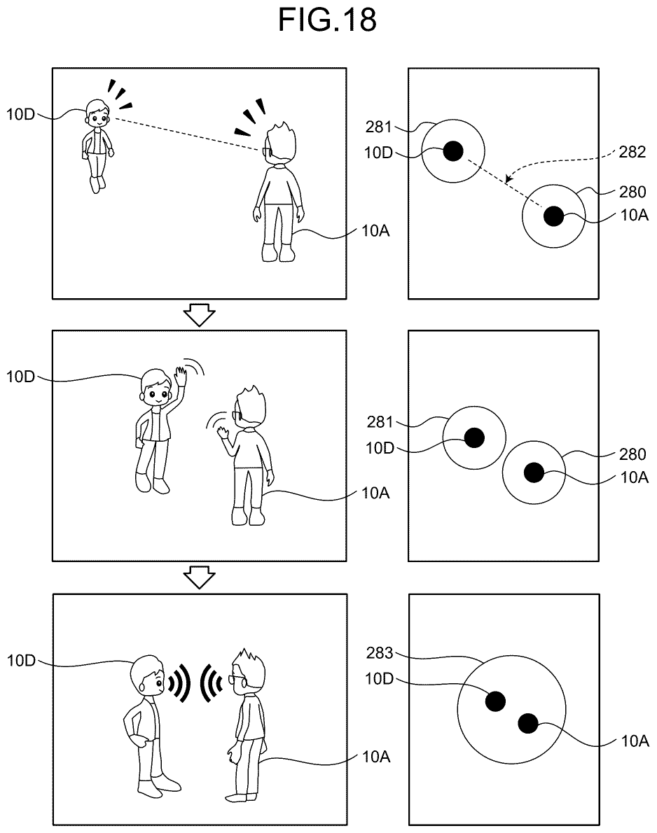

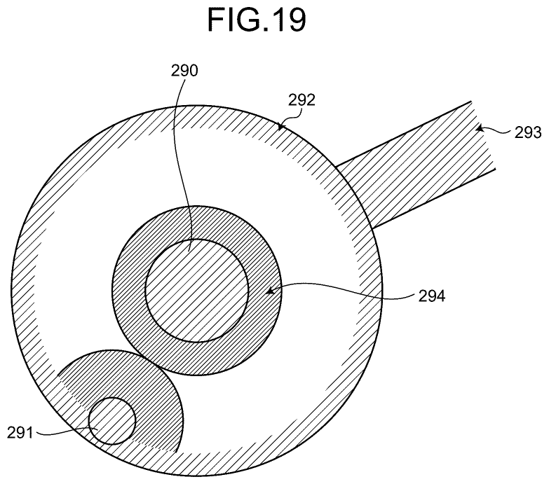

The fourth variation will be specifically described with reference to FIG. 17 and subsequent drawings. FIG. 17 is a diagram (1) for explaining the fourth variation of the display control processing of the embodiment.

A first diagram illustrated in FIG. 17 illustrates a situation in which a avatar 10D approaches a place where an avatar 10A, an avatar 10B, and an avatar 10C are talking. At this point, the avatar 10A recognizes, or by initially set viewpoint recognition, that the avatar 10D has entered the area for which the proximity is determined.

As illustrated in FIG. 2 in FIG. 17, when recognizing the proximity with the avatar 10D, the avatar 10A causes a specific action to be ignited. For example, the avatar 10A executes a gesture of raising a hand to greet. At this point, the display control device 100 may automatically display a friendly message or the like to encourage the avatar 10A to participate in the conversation with the avatar 10D.

Then, when the avatar 10D responds to the greetings and shows an intention to participate in the conversation of the avatar 10A and others, the avatar 10D participates in the conversation, as illustrated in a third diagram of FIG. 17.

In these motions, the display control device 100 makes a correction such that the avatar 10A and the avatar 10D make an eye contact or that the avatar 10A and the avatar 10D are caused to perform a gesture of greetings, or the like. As a result, the display control device 100 can cause the avatars to proactively interact with each other.

For such automatic conversation participation, the display control device 100 performs control processing on the basis of some conditions. For example, the display control device 100 determines that one or more avatars are already in a conversation (chat) state. Furthermore, the display control device 100 determines that another avatar has approached the area where the conversation is carried out. When these conditions are satisfied, the display control device 100 corrects the display such that it is easy for the avatars to have an eye contact or to perform a gesture.

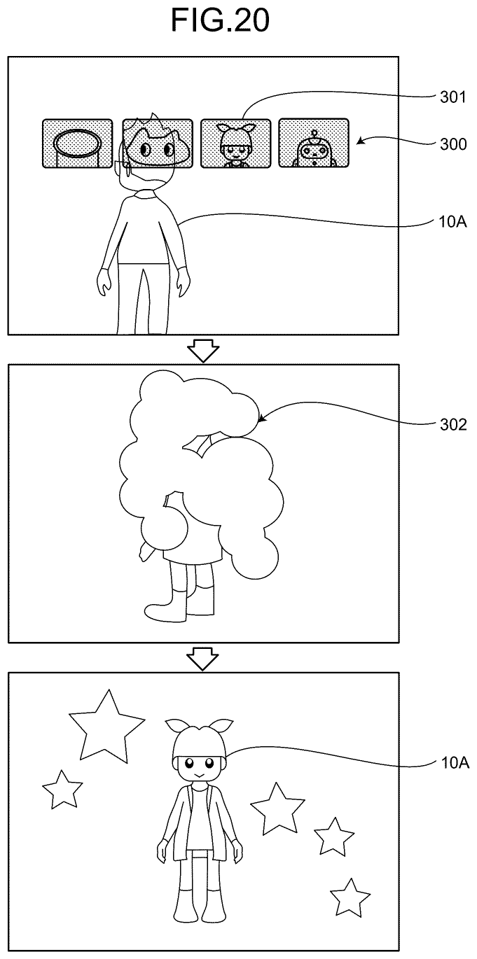

This point will be described by referring to FIG. 18. FIG. 18 is a diagram (2) for explaining the fourth variation of the display control processing of the embodiment.

As illustrated in FIG. 18, the display control device 100 recognizes a proximity area 280 of the avatar 10A and a proximity area 281 of the avatar 10D. Furthermore, the display control device 100 recognizes a distance 282 between the avatar 10A and the avatar 10D. Then, when the distance 282 falls below or equals a predetermined distance, the display control device 100 performs correction such that, for example, the avatar 10A and the avatar 10D are oriented to each other, thereby performing correction such that an eye contact is made.

Then, the display control device 100 recognizes that the proximity area 280 of the avatar 10A and the proximity area 281 of the avatar 10D have come into contact with each other. In this case, the display control device 100 ignites gestures in which the avatar 10A and the avatar 10D greet each other.

Furthermore, in a case where the avatar 10A and the avatar 10D enter the proximity area of each other, the display control device 100 starts a conversation such as a voice chat between the two. At this point, the display control device 100 newly recognizes a conversation area 283 in which a conversation between the avatar 10A and the avatar 10D is carried out.

Note that the display control device 100 may perform correction in such a manner as not to bring the avatars close to each other in a case where users indicate an intention to refuse to have a conversation when having an eye contact or when making a gesture of greeting.

Furthermore, when the avatars physically approach each other, the display control device 100 may perform control to prioritize the voice chat. As a result, the display control device 100 can create an environment in which a newly participating avatar can easily talk to an unspecified number of avatars already participating in the conversation. Note that, in a case where the user has muted voice input, the display control device 100 may prioritize the text chat.

Furthermore, the display control device 100 may set in advance an area in which conversations are encouraged and a conversation prohibited area with regard to the control of bringing avatars close to each other to encourage an interaction. This point will be described by referring to FIG. 19. FIG. 19 is a diagram (3) for explaining the fourth variation of the display control processing of the embodiment.

FIG. 19 is a diagram illustrating a situation in which some event is held in the virtual space. For example, it is based on the premise that, in the event, a specific avatar appears on a stage 290. In this case, the display control device 100 sets a conversation prohibited area 292 and a conversation prohibited area 293 to a passage or the like so that avatars do not stay in the passage that leads to the stage 290 or at positions away from the stage 290. Meanwhile, the display control device 100 sets a conversation area 294 around the stage 290 or the like in order to actively encourage conversations around the stage 290 or around a monument 291.

In this case, the display control device 100 does not perform correction for the avatars to start a conversation in the conversation prohibited area 292 or the conversation prohibited area 293. On the other hand, in the conversation area 294, the display control device 100 performs correction for the avatars to start a conversation. As a result, the display control device 100 can positively guide the conversation among the avatars in the areas where the conversation is recommended in the virtual space.

Note that the display control device 100 may correct a travelling path of the avatar 10D such that the avatar 10D can easily participate in a conversation. For example, the display control device 100 may correct the walking path or the walking speed such that the path on which the avatar 10D intends to walk automatically approaches the proximity area of the avatar 10A or an area in which the avatar 10A and others are having a conversation. Furthermore, the display control device 100 may correct the orientation of the body such that the avatar 10D can easily make an eye contact with the avatar 10A while walking.

### (1-4-5. Expression Regarding Avatar Display and Interaction)

Next, a fifth variation will be described. In the fifth variation, an example is illustrated in which the display control device 100 displays a UI for changing the appearance of an avatar 10 or exchanging items for changing the appearance between avatars.

For example, in the fifth variation, the acquisition unit 131 acquires a request to change the appearance of an avatar 10 from a user. Then, the display control unit 133 reflects a change based on the request in the avatar 10 and changes the appearance of the avatar 10 in the virtual space together with a presentation effect.

Furthermore, the acquisition unit 131 may acquire, from the user, a request to exchange any of a plurality of objects associated with a first avatar with a second avatar. In this case, when the request is acquired, the display control unit 133 displays a list of a plurality of objects associated with the first avatar in the vicinity of the first avatar.

Furthermore, the acquisition unit 131 may acquire, from the user, an instruction to select one of the plurality of objects displayed in the list for exchange with the second avatar. In this case, when the instruction is acquired, the display control unit 133 displays this object in such a manner as to be floated from the list display and moves the floated object to overlap the second avatar in the virtual space in accordance with the operation received from the user.

As described above, in the fifth variation, the display control device 100 performs display control to change the appearance of the avatar 10 or to actively encourage an exchange of items between the avatars 10. As a result, the display control device 100 can visually entertain users and actively promote interaction among users.

The fifth variation will be specifically described with reference to FIG. 20 and subsequent drawings. FIG. 20 is a diagram (1) for explaining the fifth variation of the display control processing of the embodiment.

A first diagram of FIG. 20 illustrates an example in which a change option 300 is displayed as a UI in order for the user to change the appearance of the avatar 10A. In this example, it is based on the premise that the user has selected an option 301.

A second diagram of FIG. 20 illustrates a situation in which the display control device 100 is changing the appearance of the avatar 10A. When changing the appearance of the avatar 10A, the display control device 100 may display such a presentation effect 302 that the avatar 10A is covered with smoke.

A third diagram of FIG. 20 illustrates a situation in which the display control device 100 has changed the appearance of the avatar 10A. The display control device 100 displays the changed appearance of the avatar 10A in the virtual space. In this manner, the user can desirably change the appearance of the avatar 10A.

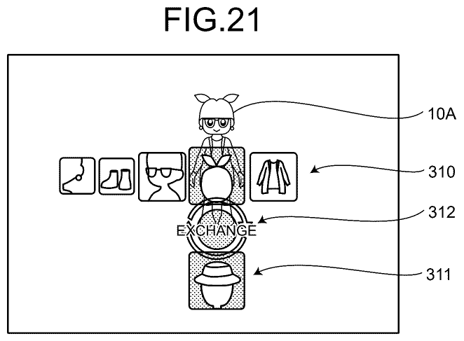

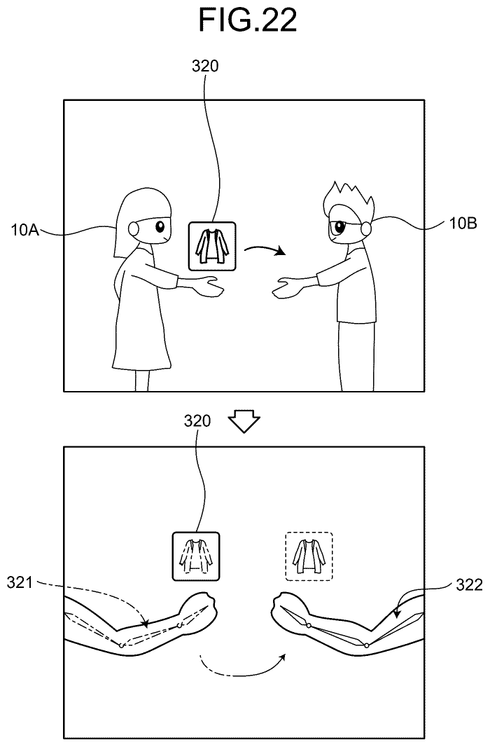

In the virtual space, a user can exchange items for changing the appearance of an avatar 10 with other users. This point will be described by referring to FIG. 21. FIG. 21 is a diagram (2) for explaining the fifth variation of the display control processing of the embodiment.

In FIG. 21, UI display for the avatar 10A and the observer to exchange items is illustrated. The avatar 10A presents an exchange option item 310 to the observer. The observer also presents an exchange option item 311. Then, when the observer selects an exchange button 312, the items are exchanged with each other. Note that, in the virtual space, there may be a concept of ownership indicating which user (avatar) owns each item. The display control device 100 may perform internal processing such that the ownership is also exchanged together with exchange of the items.

Such an item exchange between avatars may be displayed in a further different UI. This point will be described by referring to FIG. 22. FIG. 22 is a diagram (3) for explaining the fifth variation of the display control processing of the embodiment.

FIG. 22 is a diagram illustrating the avatar 10A and the avatar 10B attempting to give an item 320 for an exchange. In this case, the user corresponding to the avatar 10A selects the item 320 using a pointing device such as a mouse on screen display.

Then, the display control device 100 enlarges the display around the item 320. In the enlarged view, the user can move the item 320 closer to the avatar 10B, such as by moving the arm in the real space. In this case, the display control device 100 displays bone display 321 of the avatar 10A corresponding to the user's arm and moves the item 320 displayed near the arm of the avatar 10A toward the avatar 10B.

When the item 320 is brought closer to bone display 322 of the avatar 10B than a predetermined distance, the display control device 100 determines that the item 320 has been transferred. Then, the display control device 100 displays the item 320 in the vicinity of the bone display 322 and transfers the ownership of the item 320 to the avatar 10B.

As described above, the display control device 100 can establish the item exchange in an expression as if the avatars are actually transferring items, instead of displaying the UI indicating the item exchange.

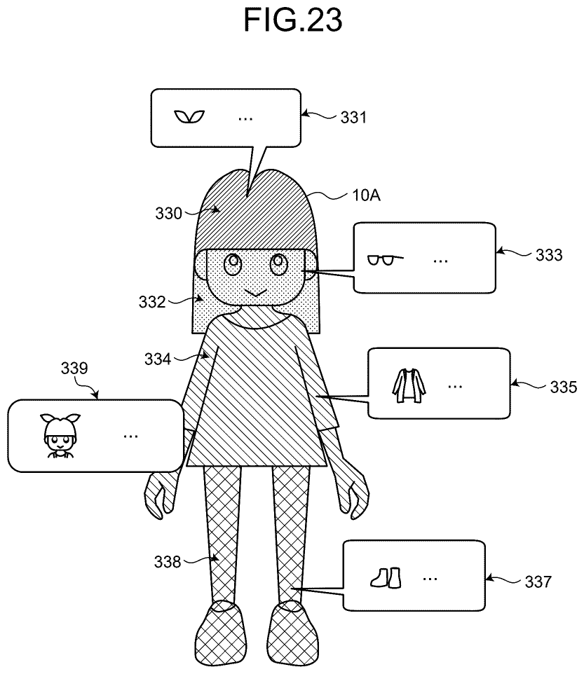

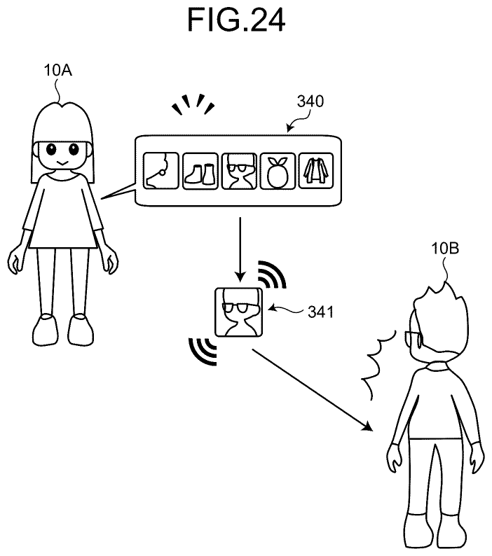

Furthermore, as described above, in a case where as item is used for the purpose of changing the appearance of the avatar 10 or the like, the display control device 100 may perform UI display corresponding to the portion to be changed. This point will be described by referring to FIG. 23. FIG. 23 is a diagram (4) for explaining the fifth variation of the display control processing of the embodiment.

As illustrated in FIG. 23, in the avatar 10A, a head 330, a face 332, a body 334, and legs 338 are set as portions for changing the appearance. In this case, the user can display a list of items that can be changed at each portion. For example, the display control device 100 displays item options 331 corresponding to the head 330. Similarly, the display control device 100 displays item options 333 corresponding to the face 332, item options 335 corresponding to the body 334, and item options 337 corresponding to the legs 338. Furthermore, the display control device 100 can also display item options 339 for changing the appearance of the entire avatar 10A.

That is, the display control device 100 displays target item options or the like in a pop-up manner for each portion where a change in the appearance of the avatar 10A is requested. Then, the display control device 100 selects an item for changing the appearance of the avatar 10A in accordance with the user's operation.

Note that the display control device 100 may, for example, in the UI display of items, superimpose an item existing in a hierarchy below that of a single selected item. For example, in a case where glasses are selected as an item for changing the face 332 of the avatar 10A, the display control device 100 may further display a plurality of item options included in a glasses category. In this case, after selecting one of the item options 333, the user can select an item in the lower hierarchy, for example, in a manner of one-stroke writing.

Furthermore, when selecting an item, the display control device 100 may set an appropriate shortcut depending on the type of device used by the user. For example, in the item selection, the display control device 100 may receive input by a key operation by a keyboard or the like together with input by a pointing device such as a mouse or a body gesture of the user.

Furthermore, the display control device 100 may perform item transfer control using UI display. This point will be described by referring to FIG. 24. FIG. 24 is a diagram (5) for explaining the fifth variation of the display control processing of the embodiment.

The example illustrated in FIG. 24 illustrates a situation in which the user selects an item 341 from among item options 340 owned by the avatar 10A. For example, the user selects the item 341 by long-pressing with a finger or a pointing device on the screen. In this case, the display control device 100 shifts the display of the item 341 to such display as if floating off from the item options 340 (floating display).

The user drags the item 341 in the floating display to the avatar 10B. By such an operation, the display control device 100 determines that the item 341 is delivered to the avatar 10B. In this manner, the display control device 100 can perform processing such as an item exchange between users using various UIs or various types of screen display. Note that, in the embodiment, what the avatars exchange in the virtual space is described as an item; however, the type of mode of the item can be desirably set by the service side that provides the virtual space. For example, the item may be data such as a non-fungible token (NFT).

### 1-5. Modifications

The processing according to the above embodiment may be accompanied by various modifications. For example, each of the devices in FIG. 3 conceptually illustrates a function in the display control system 1 and can have various modes depending on an embodiment.

For example, in the above embodiment, an example has been described in which the display control device 100 performs processing in cooperation with the analysis server 50. However, the display control device 100 may execute the processing executed by the analysis server 50 on the display control device 100 itself.

Furthermore, the display control device 100 may include a plurality of devices. For example, the display control device 100 may be divided into a first information processing device that acquires a behavior of a user as an image and performs processing related to the acquired image and a second information processing device that performs processing related to input of the voice, text, or others of the user. In this case, the first information processing device acquires the behavior of the user as an image, performs posture estimation on the basis of the image, and performs hand-up determination, head orientation determination, hand sign determination, or the like. Furthermore, the second information processing device may perform laughter determination on the basis of the voice or may perform emotion analysis or the like on the basis of the text.

Furthermore, the display control device 100 may be a device in which a display unit and an information processing unit are separately configured. In this case, the information processing unit of the display control device 100 may be a desired information processing device such as a server or a PC.

### 2. Other Embodiments

The processing according to the above embodiments may be performed in various different embodiments other than the above embodiments.

Among the processing described in the above embodiments, the whole or a part of the processing described as that performed automatically can be performed manually, or the whole or a part of the processing described as that performed manually can be performed automatically by a known method. In addition, a processing procedure, a specific name, and information including various types of data or parameters illustrated in the above or in the drawings can be modified as desired unless otherwise specified. For example, various types of information illustrated in the drawings are not limited to the information illustrated.

In addition, each component of each device illustrated in the drawings is conceptual in terms of function and is not necessarily physically configured as illustrated in the drawings. That is, the specific form of distribution or integration of devices is not limited to those illustrated in the drawings, and the whole or a part thereof can be functionally or physically distributed or integrated in any unit depending on various loads, usage status, and others.

In addition, the above embodiments and modifications can be combined as appropriate within a range where there is no conflict in the processing content.

Furthermore, the effects described herein are merely examples and are not limiting, and other effects may be achieved.

### 3. Effects of Display Control Device According to Present Disclosure

As described above, the display control device (display control device 100 in the embodiment) according to the present disclosure includes the acquisition unit (acquisition unit 131 in the embodiment), the determination unit (determination unit 132 in the embodiment), and the display control unit (display control unit 133 in the embodiment). The acquisition unit acquires the behavior of a user in the real space as input information. The determination unit determines whether or not input corresponding to a specific motion registered in advance is included in the input information. The display control unit reflects the behavior of the user corresponding to the input information in an avatar in the virtual space, and in a case where it is determined that the input information includes the input corresponding to the specific motion, further reflects the specific motion in the avatar in the virtual space to display the avatar in the virtual space.

As described above, the display control device according to the present disclosure displays the avatar by combining an unintentional motion accompanying a natural motion of the user and an intentional motion for activating a gesture. As a result, the display control device can display the avatar in the virtual space in various expressions including not only the motion of the user as it is but also with cartoonish expressions.

Furthermore, the acquisition unit receives designation from the user as to whether or not to reflect a specific motion in the avatar. In a case where the user designates, the determination unit determines whether or not the input information includes the input corresponding to the specific motion.

Furthermore, the acquisition unit acquires a position from the imaging device when the behavior of the user is photographed. The determination unit does not determine whether or not the input corresponding to the specific motion is included in the input information in a case where the position from the imaging device is apart by a distance greater than a predetermined distance and determines whether or not the input corresponding to the specific motion is included in the input information in a case where the position from the imaging device is within the predetermined distance.

As described above, the display control device according to the present disclosure reflects the intentional motion in the avatar when the user specifies that an intentional motion be performed or when a gesture is performed by the user in a specific area. As a result, the display control device can perform avatar expression in accordance with the user's intention.

Furthermore, the acquisition unit acquires behaviors of a plurality of users as input information. The determination unit determines the liveliness of interaction among a plurality of users in the virtual space on the basis of behaviors of the plurality of users. The display control unit displays a presentation effect depending on the liveliness of the interaction in the vicinity of the plurality of users.

Furthermore, the determination unit determines the liveliness of the interaction on the basis of the number of users participating in the interaction, the frequency of the conversation among the users, and the degree of overlapping of the voices of the plurality of users.

Furthermore, the display control unit determines the expression or occurrence frequency of a presentation effect on the basis of the liveliness of the interaction, the orientation of the body of an avatar, and the content of the conversations of the plurality of users.

As described above, by visually displaying the liveliness of the conversation among the avatars, the display control device according to the present disclosure can effectively illustrate a situation in which the avatars actively interact with each other even to a user who is not participating in the conversation.

Furthermore, the determination unit determines whether or not the input information includes input corresponding to a specific motion associated with specific emotion. In a case where it is determined that the input information includes the specific motion associated with the specific emotion, the display control unit reflects the specific motion associated with the specific emotion in the avatar to display the avatar in the virtual space.

The determination unit further determines whether or not the input information includes the input corresponding to the specific motion associated with the specific emotion by comparing voiceprint information associated with the specific emotion with the input information, the voiceprint information registered in advance by the user.

Furthermore, the display control unit displays the avatar reflecting the specific motion associated with the specific emotion and displays a presentation effect associated with the specific emotion in the vicinity of the avatar.

As described above, the display control device according to the present disclosure can reflect a gesture associated with a specific emotion, such as a laughter, in the avatar. As a result, the display control device can express various emotional expressions also in the virtual space as in the real space.

The display control unit displays words uttered by the avatar on the basis of the input information and further displays a history of the words in such a manner as to transition upward starting from the avatar.

Furthermore, the display control unit displays a word uttered by the avatar as an icon representing the semantic content with a picture on the basis of the semantic content included in the input information.

Furthermore, the determination unit determines a distance between the position in the virtual space from which the display of the word is observed and the position of the avatar that utters the word. The display control unit displays the history of words or an icon as a presentation effect not including the words or the semantic content of the icon on the basis of the determined distance.

Furthermore, the determination unit determines a positional relationship between the position in the virtual space from which the display of the word is observed and the position of the avatar that utters the words. The display control unit determines the display angle and the three-dimensional display of the words observed in the virtual space on the basis of the determined positional relationship.

As described above, the display control device according to the present disclosure can display in such a manner that the user can grasp at a glance where active communication is being carried out without complicating the screen display by expressing the history of the conversation in various modes.

Furthermore, the determination unit determines whether or not the first avatar is included in an area recognized by the second avatar in the virtual space. In a case where it is determined that the first avatar is included in the area recognized by the second avatar, the display control unit adjusts the travelling path of the first avatar such that the first avatar approaches the second avatar.

Furthermore, the determination unit determines whether or not the first avatar has approached the second avatar in the virtual space. In a case where it is determined that the first avatar has approached the second avatar, the display control unit reflects, in at least one of the first avatar or the second avatar, a specific motion corresponding to the proximity to display the first avatar and the second avatar.

As described above, the display control device according to the present disclosure can promote the avatars to actively interact with each other by correcting the behaviors between the avatars. As a result, the display control device can increase opportunities for conversation among users in the virtual space, whereby the interaction in the virtual space can be activated.

Furthermore, the acquisition unit acquires a request to change the appearance of the avatar from the user. The display control unit reflects the change based on the request in the avatar and changes the appearance of the avatar in the virtual space together with a presentation effect.

The acquisition unit acquires, from the user, a request to exchange any of a plurality of objects associated with the first avatar with the second avatar. When the request is acquired, the display control unit displays a list of the plurality of objects associated with the first avatar in the vicinity of the first avatar.

Furthermore, the acquisition unit acquires, from the user, an instruction to select one of the plurality of objects displayed in the list for exchange with the second avatar. When the instruction is acquired, the display control unit displays this object in such a manner as to be floated from the list display and moves the floated object to overlap the second avatar in the virtual space in accordance with the operation received from the user.

As described above, the display control device according to the present disclosure reduces the stress of the user in the interaction such as exchanging items between users by providing the UI having excellent operability. As a result, the display control device can support active interaction among the users.

### 4. Hardware Configuration

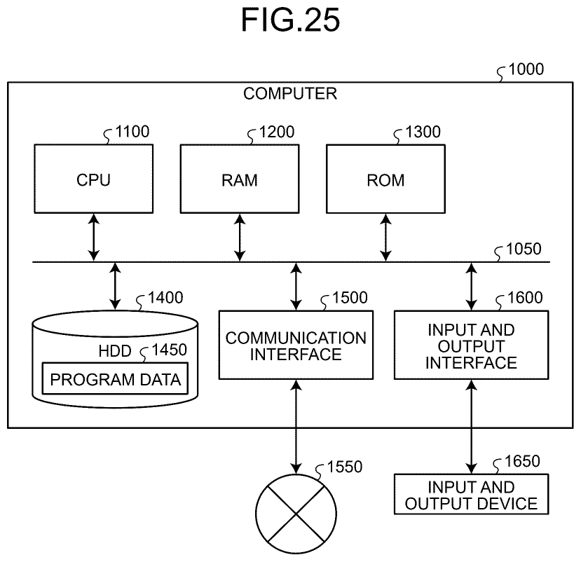

An information device such as the display control devices 100 according to the embodiments described above is implemented by, for example, a computer 1000 having a configuration as illustrated in FIG. 25. Hereinafter, the display control device 100 will be described as an example. FIG. 25 is a hardware configuration diagram illustrating an example of the computer 1000 that implements the functions of the display control device 100. The computer 1000 includes a CPU 1100, a RAM 1200, a read only memory (ROM) 1300, a hard disk drive (HDD) 1400, a communication interface 1500, and an input and output interface 1600. The components of the computer 1000 are connected by a bus 1050.

The CPU 1100 operates in accordance with a program stored in the ROM 1300 or the HDD 1400 and controls each of the components. For example, the CPU 1100 loads a program stored in the ROM 1300 or the HDD 1400 in the RAM 1200 and executes processing corresponding to various programs.

The ROM 1300 stores a boot program such as a basic input output system (BIOS) executed by the CPU 1100 when the computer 1000 is activated, a program dependent on the hardware of the computer 1000, and the like.

The HDD 1400 is a computer-readable recording medium that non-transiently records a program to be executed by the CPU 1100, data used by such a program, and the like. Specifically, the HDD 1400 is a recording medium that records the display control program according to the present disclosure, which is an example of program data 1450.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 is an interface for connecting an input and output device 1650 and the computer 1000. For example, the CPU 1100 receives data from an input device such as a keyboard or a mouse via the input and output interface 1600. The CPU 1100 also transmits data to an output device such as a display, a speaker, or a printer via the input and output interface 1600. Furthermore, the input and output interface 1600 may function as a media interface that reads a program or the like recorded in a predetermined recording medium. A medium refers to, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in a case where the computer 1000 functions as the display control device 100 according to the embodiment, the CPU 1100 of the computer 1000 implements the function of the control unit 130 or other units by executing the display control program loaded on the RAM 1200. The HDD 1400 also stores the display control program according to the present disclosure or data in the storage unit 120. Note that although the CPU 1100 reads the program data 1450 from the HDD 1400 and executes the program, as another example, these programs may be acquired from another device via the external network 1550.

Note that the present technology can also have the following configurations.
(1) A display control device comprising:
   an acquisition unit that acquires a behavior of a user in a real space as input information;
   a determination unit that determines whether or not input corresponding to a specific motion registered in advance is included in the input information; and
   a display control unit that reflects the behavior of the user corresponding to the input information in an avatar in a virtual space, and in a case where it is determined that the input information includes the input corresponding to the specific motion, further reflects the specific motion in the avatar in the virtual space to display the avatar in the virtual space.
(2) The display control device according to (1), wherein
   the acquisition unit
   receives, from the user, a designation as to whether or not to reflect the specific motion in the avatar, and
   the determination unit
   determines whether or not the input corresponding to the specific motion is included in the input information in a case where there is the designation by the user.
(3) The display control device according to (1) or (2), wherein
   the acquisition unit
   acquires a position from an imaging device when the behavior of the user is photographed, and
   the determination unit
   does not determine whether or not the input corresponding to the specific motion is included in the input information in a case where the position from the imaging device is apart by a distance greater than a predetermined distance and determines whether or not the input corresponding to the specific motion is included in the input information in a case where the position from the imaging device is within the predetermined distance.
(4) The display control device according to any one of (1) to (3), wherein
   the acquisition unit
   acquires behaviors of a plurality of users as input information,
   the determination unit
   determines liveliness of an interaction between the plurality of users in the virtual space on a basis of the behaviors of the plurality of users, and
   the display control unit
   displays a presentation effect depending on the liveliness of the interaction in a vicinity of the plurality of users.
(5) The display control device according to (4), wherein
   the determination unit
   determines the liveliness of the interaction on a basis of a number of users participating in the interaction, a frequency of conversation between the users, and a degree of overlapping of voices of the plurality of users.
(6) The display control device according to (5), wherein
   the display control unit
   determines an expression or occurrence frequency of the presentation effect on a basis of the liveliness of the interaction, orientation of a body of the avatar, and content of the conversations of the plurality of users.
(7) The display control device according to any one of (1) to (6), wherein
   the determination unit
   determines whether or not input corresponding to the specific motion associated with specific emotion is included in the input information, and
   the display control unit,
   in a case where it is determined that the input information includes the specific motion associated with the specific emotion, reflects the specific motion associated with the specific emotion in the avatar and displays the avatar in the virtual space.
(8) The display control device according to (7), wherein
   the determination unit
   determines whether or not the input corresponding to the specific motion associated with the specific emotion is included in the input information by comparing voiceprint information associated with the specific emotion with the input information, the voiceprint information registered in advance by the user.
(9) The display control device according to (7) or (8), wherein
   the display control unit
   displays the avatar reflecting the specific motion associated with the specific emotion and displays a presentation effect associated with the specific emotion in a vicinity of the avatar.
(10) The display control device according to any one of (1) to (9), wherein
   the display control unit
   displays words uttered by the avatar on a basis of the input information and further displays a history of the words in such a manner as to transition upward starting from the avatar.
(11) The display control device according to (10), wherein
   the display control unit
   displays a word uttered by the avatar as an icon on a basis of semantic content included in the input information, the icon representing the semantic content with a picture.
(12) The display control device according to (11), wherein
   the determination unit
   determines a distance between a position in the virtual space for observing display of the word and a position of an avatar that utters the word, and
   the display control unit
   displays a history of the word or the icon as a presentation effect not including the word nor the semantic content of the icon on the basis of the determined distance.
(13) The display control device according to (11) or (12), wherein
   the determination unit
   determines a positional relationship between a position in the virtual space for observing display of the word and a position of an avatar that utters the word, and
   the display control unit
   determines a display angle and a three-dimensional display of the word observed in the virtual space on a basis of the determined positional relationship.
(14) The display control device according to any one of (1) to (13), wherein
   the determination unit
   determines whether or not a first avatar is included within an area recognized by a second avatar in the virtual space, and
   the display control unit
   adjusts a travelling path of the first avatar such that the first avatar approaches the second avatar in a case where it is determined that the first avatar is included in the area recognized by the second avatar.
(15) The display control device according to (14), wherein
   the determination unit
   determines whether or not the first avatar has approached the second avatar in the virtual space, and
   the display control unit,
   in a case where it is determined that the first avatar has approached the second avatar, reflects a specific motion corresponding to the approach in at least one of the first avatar or the second avatar to display the first avatar and the second avatar.
(16) The display control device according to any one of (1) to (15), wherein
   the acquisition unit
   acquires, from the user, a request to change an appearance of the avatar, and
   the display control unit
   reflects a change based on the request in the avatar to change the appearance of the avatar in the virtual space together with a presentation effect.
(17) The display control device according to any one of (1) to (16), wherein
   the acquisition unit
   acquires, from the user, a request to exchange any of a plurality of objects associated with a first avatar with a second avatar, and
   the display control unit
   displays a list of the plurality of objects associated with the first avatar in a vicinity of the first avatar when the request is acquired.
(18) The display control device according to (17), wherein
   the acquisition unit
   acquires, from the user, an instruction to select any object among the plurality of objects displayed in the list for exchange with the second avatar, and
   the display control unit,
   when the instruction is acquired, displays the object in such a manner as to be floating from the displayed list and moves the floated object to overlap the second avatar in the virtual space in accordance with an operation received from the user.
(19) A display control method comprising:
   by a computer,
   acquiring a behavior of a user in a real space as input information;
   determining whether or not input corresponding to a specific motion registered in advance is included in the input information; and
   reflecting the behavior of the user corresponding to the input information in an avatar in a virtual space, and in a case where it is determined that the input information includes the input corresponding to the specific motion, further reflecting the specific motion in the avatar in the virtual space to display the avatar in the virtual space.
(20) A display control program for causing a computer to function as a display control device, wherein the display control device includes:
   an acquisition unit that acquires a behavior of a user in a real space as input information;
   a determination unit that determines whether or not input corresponding to a specific motion registered in advance is included in the input information; and
   a display control unit that reflects the behavior of the user corresponding to the input information in an avatar in a virtual space, and in a case where it is determined that the input information includes the input corresponding to the specific motion, further reflects the specific motion in the avatar in the virtual space to display the avatar in the virtual space.

### REFERENCE SIGNS LIST

10 AVATAR
50 ANALYSIS SERVER
100 DISPLAY CONTROL DEVICE
110 COMMUNICATION UNIT
120 STORAGE UNIT
130 CONTROL UNIT
131 ACQUISITION UNIT
132 DETERMINATION UNIT
133 DISPLAY CONTROL UNIT
140 SENSOR UNIT
141 CAMERA
142 MICROPHONE
150 DISPLAY UNIT

1. A display control device comprising:
an acquisition unit that acquires a behavior of a user in a real space as input information;
a determination unit that determines whether or not input corresponding to a specific motion registered in advance is included in the input information; and
a display control unit that reflects the behavior of the user corresponding to the input information in an avatar in a virtual space, and in a case where it is determined that the input information includes the input corresponding to the specific motion, further reflects the specific motion in the avatar in the virtual space to display the avatar in the virtual space.

2. The display control device according to claim 1, wherein
the acquisition unit
receives, from the user, a designation as to whether or not to reflect the specific motion in the avatar, and
the determination unit
determines whether or not the input corresponding to the specific motion is included in the input information in a case where there is the designation by the user.

3. The display control device according to claim 1, wherein
the acquisition unit
acquires a position from an imaging device when the behavior of the user is photographed, and
the determination unit
does not determine whether or not the input corresponding to the specific motion is included in the input information in a case where the position from the imaging device is apart by a distance greater than a predetermined distance and determines whether or not the input corresponding to the specific motion is included in the input information in a case where the position from the imaging device is within the predetermined distance.

4. The display control device according to claim 1, wherein
the acquisition unit
acquires behaviors of a plurality of users as input information,
the determination unit
determines liveliness of an interaction between the plurality of users in the virtual space on a basis of the behaviors of the plurality of users, and
the display control unit
displays a presentation effect depending on the liveliness of the interaction in a vicinity of the plurality of users.

5. The display control device according to claim 4, wherein
the determination unit
determines the liveliness of the interaction on a basis of a number of users participating in the interaction, a frequency of conversation between the users, and a degree of overlapping of voices of the plurality of users.

6. The display control device according to claim 5, wherein
the display control unit
determines an expression or occurrence frequency of the presentation effect on a basis of the liveliness of the interaction, orientation of a body of the avatar, and content of the conversations of the plurality of users.

7. The display control device according to claim 1, wherein
the determination unit
determines whether or not input corresponding to the specific motion associated with specific emotion is included in the input information, and
the display control unit,
in a case where it is determined that the input information includes the specific motion associated with the specific emotion, reflects the specific motion associated with the specific emotion in the avatar and displays the avatar in the virtual space.

8. The display control device according to claim 7, wherein
the determination unit
determines whether or not the input corresponding to the specific motion associated with the specific emotion is included in the input information by comparing voiceprint information associated with the specific emotion with the input information, the voiceprint information registered in advance by the user.

9. The display control device according to claim 7, wherein
the display control unit
displays the avatar reflecting the specific motion associated with the specific emotion and displays a presentation effect associated with the specific emotion in a vicinity of the avatar.

10. The display control device according to claim 1, wherein
the display control unit
displays words uttered by the avatar on a basis of the input information and further displays a history of the words in such a manner as to transition upward starting from the avatar.

11. The display control device according to claim 10, wherein
the display control unit
displays a word uttered by the avatar as an icon on a basis of semantic content included in the input information, the icon representing the semantic content with a picture.

12. The display control device according to claim 11, wherein
the determination unit
determines a distance between a position in the virtual space for observing display of the word and a position of an avatar that utters the word, and
the display control unit
displays a history of the word or the icon as a presentation effect not including the word nor the semantic content of the icon on the basis of the determined distance.

13. The display control device according to claim 11, wherein
the determination unit
determines a positional relationship between a position in the virtual space for observing display of the word and a position of an avatar that utters the word, and
the display control unit
determines a display angle and a three-dimensional display of the word observed in the virtual space on a basis of the determined positional relationship.

14. The display control device according to claim 1, wherein
the determination unit
determines whether or not a first avatar is included within an area recognized by a second avatar in the virtual space, and
the display control unit
adjusts a travelling path of the first avatar such that the first avatar approaches the second avatar in a case where it is determined that the first avatar is included in the area recognized by the second avatar.

15. The display control device according to claim 14, wherein
the determination unit
determines whether or not the first avatar has approached the second avatar in the virtual space, and
the display control unit,
in a case where it is determined that the first avatar has approached the second avatar, reflects a specific motion corresponding to the approach in at least one of the first avatar or the second avatar to display the first avatar and the second avatar.

16. The display control device according to claim 1, wherein
the acquisition unit
acquires, from the user, a request to change an appearance of the avatar, and
the display control unit
reflects a change based on the request in the avatar to change the appearance of the avatar in the virtual space together with a presentation effect.

17. The display control device according to claim 1, wherein
the acquisition unit
acquires, from the user, a request to exchange any of a plurality of objects associated with a first avatar with a second avatar, and
the display control unit
displays a list of the plurality of objects associated with the first avatar in a vicinity of the first avatar when the request is acquired.

18. The display control device according to claim 17, wherein
the acquisition unit
acquires, from the user, an instruction to select any object among the plurality of objects displayed in the list for exchange with the second avatar, and
the display control unit,
when the instruction is acquired, displays the object in such a manner as to be floating from the displayed list and moves the floated object to overlap the second avatar in the virtual space in accordance with an operation received from the user.

19. A display control method comprising:
by a computer,
acquiring a behavior of a user in a real space as input information;
determining whether or not input corresponding to a specific motion registered in advance is included in the input information; and
reflecting the behavior of the user corresponding to the input information in an avatar in a virtual space, and in a case where it is determined that the input information includes the input corresponding to the specific motion, further reflecting the specific motion in the avatar in the virtual space to display the avatar in the virtual space.

20. A display control program for causing a computer to function as a display control device, wherein the display control device includes:
an acquisition unit that acquires a behavior of a user in a real space as input information;
a determination unit that determines whether or not input corresponding to a specific motion registered in advance is included in the input information; and
a display control unit that reflects the behavior of the user corresponding to the input information in an avatar in a virtual space, and in a case where it is determined that the input information includes the input corresponding to the specific motion, further reflects the specific motion in the avatar in the virtual space to display the avatar in the virtual space.
